(19) United States
(12) Patent Application Publication
(10) Pub. No.: US 2013/0128359 A1
(43) Pub. Date: May 23, 2013

(54) OPTICAL FILM, POLARIZING PLATE, AND LIQUID CRYSTAL DISPLAY APPARATUS

(71) Applicant: FUJIFILM CORPORATION, Tokyo (JP)

(72) Inventors: Taku WAKITA, Kanagawa (JP); Takashi TAMADA, Kanagawa (JP); Akihiro MATSUFUJI, Kanagawa (JP); Jun TAKEDA, Kanagawa (JP)

(73) Assignee: FUJIFILM CORPORATION, Tokyo (JP)

(21) Appl. No.: 13/679,482

(22) Filed: Nov. 16, 2012

(30) Foreign Application Priority Data
Nov. 21, 2011 (JP) 2011-253577
Nov. 2, 2012 (JP) 2012-242559

(51) Int. Cl. G02B 5/30

(52) U.S. Cl. CPC G02B 5/30
USPC 359/489.07; 536/56; 428/220; 106/163.01

(57) ABSTRACT

An optical film having a high Re and a low |Rth| is provided. An optical film consists of a composition that includes cellulose acylate having an acyl group including an aromatic group, and satisfies Formula (I) 150 nm≦Re (550)≦350 nm, Formula (II) −50 nm≦Rth (550)≦50 nm, and Formula (III) 0.07 nm≦degree of cross-sectional orientation P2z≦1, Here, Re (550) represents the in-plane retardation at a wavelength of 550 nm, and Rth (550) represents the thickness direction retardation at a wavelength of 550 nm.

### BACKGROUND OF THE INVENTION

1. Field of the Invention

The present invention relates to an optical film that is useful as a member or the like of a liquid crystal display apparatus, a polarizing plate and a liquid crystal display apparatus in which the optical film is used.

2. Description of the Related Art

An optical film exhibiting appropriate optical characteristics is used for optical compensation of a liquid crystal display apparatus depending on the orientation mode. For example, an optical compensation for which an optical film having a large Re and a small absolute value of Rth is used is known as an example of the optical compensation of an IPS mode liquid crystal display apparatus. As a film exhibiting the above characteristics, JP2009-235374A proposes a cellulose acylate film consisting of a composition that includes cellulose acylate which has an acyl group (substituent A) including an aromatic group and in which the degree of substitution of the substituent A satisfies predetermined conditions.

### SUMMARY OF THE INVENTION

However, in manufacturing the cellulose acylate film disclosed in the cited document 1, it is necessary to adjust the degree of substitution of the substituent A depending on the substitution site (2, 3, and 6 sites of cellulose), and therefore manufacturing and procurement of raw materials are difficult. In addition, when |Rth| is decreased by controlling the degree of substitution or substation site of the substituent A in order to attain more ideal optical characteristics, there is another problem in that Re also changes, and therefore techniques that achieve a high Re and a low |Rth| have limitations.

An object of the invention is to solve the above problems.

Specifically, the object is to provide a novel optical film exhibiting optical characteristics of a high Re and a low |Rth|, a polarizing plate and a liquid crystal display apparatus in which the optical film is used.

Means for solving the above problems are as follows.

[1] An optical film which consists of a composition that includes cellulose acylate having an acyl group including an aromatic group and satisfies the following formulae (I) to (III):

150 nm≦Re (550)≦350 nm Formula (I)

−50 nm≦Rth (550)≦50 nm Formula (II)

0.07 nm≦degree of cross-sectional orientation P2z≦1 Formula (III)

Here, Re (550) represents the in-plane retardation at a wavelength of 550 nm, and Rth (550) represents the thickness direction retardation at a wavelength of 550 nm.

[2] The optical film according to the above [1], in which the ratio VT/VM of the sound velocity VT in the width direction of the film to the sound velocity VM in the longitudinal direction of the film is 1.0 to 1.4.

[3] The optical film according to the above [2], in which the predetermined direction is a slow axis direction of the film.

[4] The optical film according to any one of the above [1] to [3], in which the acyl group including the aromatic group is selected from a benzoyl group, a phenylbenzoyl group, a 4-heptylbenzoyl group, a 2,4,5-trimethoxybenzoyl group, and a 3,4,5-trimethoxybenzoyl group.

[5] The optical film according to any one of the above [1] to [4] further having an aliphatic acyl group.

[6] The optical film according to the above [5], in which the aliphatic acyl group is one or two or more aliphatic acyl groups selected from an acetyl group, a propionyl group, and a butyryl group.

[7] The optical film according to any one of the above [1] to [6] which is a biaxially drawn film.

[8] The optical film according to any one of the above [1] to [7], in which the film thickness is 40 μm to 70 μm.

[9] The optical film according to any one of the above [1] to [8] further containing at least one plasticizer.

[10] A polarizing plate having at least the optical film according to any one of the above [1] to [9] and a polarizer.

[11] A liquid crystal display apparatus having the polarizing plate according to the above [10].

[12] A method of manufacturing a cellulose acylate film that satisfies the following formulae (I) and (II), including

a film-forming process in which a composition that includes cellulose acylate having an acyl group including an aromatic group is formed into a film, and

a drawing process in which a drawing treatment is carried out on the obtained film,

in which the drawing treatment is carried out under a condition that the degree of cross-sectional orientation P2z of the drawn film satisfies the following formula (III)

150 nm≦Re (550)≦350 nm Formula (I)

−50 nm≦Rth (550)≦50 nm Formula (II)

0.07 nm≦degree of cross-sectional orientation P2z≦1 Formula (III)

Here, Re (550) represents the in-plane retardation at a wavelength of 550 nm, and Rth (550) represents the thickness direction retardation at a wavelength of 550 nm.

[13] The method according to the above [12], in which the drawing process is a process in which biaxial drawing that carries out a drawing treatment on the formed film in a film-forming direction and a direction orthogonal to the film-forming direction is carried out.

[14] The method according to the above [12] or [13], in which the drawing process is a process in which the formed film is drawn in the film-forming direction at a draw ratio r_{MD}, and then is drawn in the direction orthogonal to the film-forming direction at a draw ratio r_{TD} (here, r_{MD}<r_{TD}).

According to the invention, it is possible to provide a novel optical film exhibiting optical characteristics of a high Re and a low |Rth|, a polarizing plate and a liquid crystal display apparatus in which the optical film is used.

### DESCRIPTION OF THE PREFERRED EMBODIMENTS

Hereinafter, the invention will be described in detail.

Meanwhile, in the present specification, “to” has a meaning of including numeric values before and after the “to” as the lower limit value and the upper limit value.

1. Optical Film

The invention relates to an optical film which consists of a composition that includes cellulose acylate having an acyl group including an aromatic group (hereinafter sometimes referred to as the “aromatic acyl group”) as a principle component and satisfies the following formulae (I) to (III):

150 nm≦Re (550)≦350 nm Formula (I)

−50 nm≦Rth (550)≦50 nm Formula (II)

0.07 nm≦degree of cross-sectional orientation P2z≦1 Formula (III)

Here, Re (550) represents the in-plane retardation at a wavelength of 550 nm, and Rth (550) represents the thickness direction retardation at a wavelength of 550 nm.

As a result of thorough studies by the present inventors, it was found that the development of the optical characteristics can be controlled by adjusting the degree of cross-sectional orientation P2z of the film. The degree of cross-sectional orientation P2z refers to an index of molecular orientation in the film thickness direction. It was found that a film having optical characteristics that satisfy the formulae (I) and (II), that is, a film having a high Re and a low |Rth| can be obtained by adjusting the degree of cross-sectional orientation P2z of the film including cellulose acylate having an aromatic acyl group as a principle component to 0.07 to 1. The degree of cross-sectional orientation that satisfies the formula (III) can be achieved by carrying out a biaxial drawing treatment or a high-magnification drawing treatment after film formation, whereby a film having a high Re and a low |Rth| can be manufactured. On the other hand, in the past, a general tendency was known that Rth increases when a biaxial drawing treatment is carried out on a film including cellulose acylate having an aromatic acyl group (for example, cellulose acetate) as a principle component, and thus the fact that the above optical characteristics can be achieved by satisfying the formula (III) could not be anticipated based on past knowledge.

Meanwhile, in the invention, unlike JP2009-235374A, it is not necessary to adjust the degree of substitution of the aromatic acyl group in cellulose acylate depending on the substitution site. Meanwhile, for the optical film of the invention, the degree of cross-sectional orientation P2z is adjusted, and the formula (III) is satisfied. For example, like the examples in JP2009-235374A, even when Re is increased through a uniaxial drawing treatment so as to satisfy the formula (I), the degree of cross-sectional orientation P2z becomes less than 0.07, which does not satisfy the formula (III). In addition, |Rth| also increases so as to become outside the range of the formula (II).

Hereinafter, materials, manufacturing methods, and characteristics that can be used to manufacture the optical film of the invention will be described in detail.

(1) Cellulose Acylate

The optical film of the invention consists of a composition that contains at least one kind of cellulose acylate having at least an acyl group (substituent A) including an aromatic group. Cellulose has free hydroxyl groups at ligand-binding sites 2, 3, and 6 per glucose unit that forms a β-1,4 bond. The substitution sites of the substituent A in the cellulose acylate may be any of the ligand-binding sites 2, 3, and 6, and the degree of substitution at the respective substitution sites is also not particularly limited. The degree of substitution of the substituent A is preferably 0.5 to 1.5, and more preferably 0.7 to 1.3. When the degree of substitution of the substituent A is less than 0.5, the development of Re decreases, and it becomes difficult to realize a high Re. In addition, when the degree of substitution of the substituent A is larger than 1.5, it is difficult to manufacture raw materials since synthesis takes a long time, and the like.

Meanwhile, plural kinds of acyl groups including an aromatic group may be used, and, in a case in which plural kinds of acyl groups including an aromatic group are used, the degree of substitution is the total degree. One kind of acyl group including an aromatic group is preferably used in terms of synthesis.

In addition, the degree of overall substitution DS (the degree of overall substitution including not only the degree of substitution by the substituent A but also the degree of substitution by a substituent B to be described below) by acyl groups in the cellulose acylate is preferably 2.2 to 3.0, more preferably 2.5 to 2.95, and still more preferably 2.5 to 2.9. A degree of overall substitution DS within the above range is preferable from the viewpoint of decreasing the temperature reliance of Rth.

The degree of substitution and substitution distribution of the substituent in the invention can be determined through ¹H-NMR or ¹³C-NMR using a method described in Cellulose Communication 6, 73 to 79 (1999) and Chirality 12 (9), 670 to 674.

Acyl Group (Substituent A) Including an Aromatic Group

In the invention, the acyl group (substituent A) including an aromatic group may bond directly or through a linking group with an ester bonding portion. The acyl group preferably bonds directly with the ester bonding portion. The linking group mentioned herein indicates an alkylene group, an alkenylene group, or an alkynylene group, and the linking group may have a substituent. The linking group is preferably an alkylene group, an alkenylene group, or an alkynylene group which have one to ten atoms, more preferably an alkylene group or an alkynylene group which have one to six atoms, and most preferably an alkylene group or an alkenylene group which have one to four atoms.

In addition, the aromatic group may have a substituent, and the substituent substituted into an aromatic group and the substituent substituted into the linking group are, for example, an alkyl group (having preferably 1 to 20 atoms, more preferably 1 to 12 atoms, and particularly preferably 1 to 8 atoms, and examples thereof include a methyl group, an ethyl group, a propyl group, an isopropyl group, a tert-butyl group, an n-butyl group, an n-octyl group, an n-decyl group, an n-hexadecyl group, a cyclopropyl group, a cyclopentyl group, a cyclohexyl group, and the like), an alkenyl group (having preferably 2 to 20 carbon atoms, more preferably 2 to 12 carbon atoms, and particularly preferably 2 to 8 carbon atoms, and examples thereof include a vinyl group, an aryl group, a 2-butenyl group, a 3-pentenyl group, and the like), an alkynyl group (having preferably 2 to 20 carbon atoms, more preferably 2 to 12 carbon atoms, and particularly preferably 2 to 8 carbon atoms, and examples thereof include a propargyl group, a 3-pentynyl group, and the like), an aryl group (having preferably 6 to 30 carbon atoms, more preferably 6 to 20 carbon atoms, and particularly preferably 6 to 12 carbon atoms, and examples thereof include a phenyl group, a biphenyl group, a naphthyl group, and the like), an amino group (having preferably 0 to 20 carbon atoms, more preferably 0 to 10 carbon atoms, and particularly preferably 0 to 6 carbon atoms, and examples thereof include an amino group, a methylamino group, a dimethylamino group, a diethylamino group, a dibenzylamino group, and the like), an alkoxy group (having preferably 1 to 20 carbon atoms, more preferably 1 to 12 carbon atoms, and particularly preferably 1 to 8 carbon atoms, and examples thereof include a methoxy group, an ethoxy group, a butoxy group, and the like), an aryloxy group (having preferably 6 to 20 carbon atoms, more preferably 6 to 16 carbon atoms, and particularly preferably 6 to 12 carbon atoms, and examples thereof include a phenyloxy group, a 2-naphthyloxy group, and the like), an acyl group (having preferably 1 to 20 carbon atoms, more preferably 1 to 16 carbon atoms, and particularly preferably 1 to 12 carbon atoms, and examples thereof include an acetyl group, a benzoyl group, a formyl group, a pivaloyl group, and the like), an alkoxycarbonyl group (having preferably 2 to 20 carbon atoms, more preferably 2 to 16 carbon atoms, and particularly preferably 2 to 12 carbon atoms, and examples thereof include a methoxycarbonyl group, an ethoxycarbonyl group, and the like), an aryloxycarbonyl group (having preferably 7 to 20 carbon atoms, more preferably 7 to 16 carbon atoms, and particularly preferably 7 to 10 carbon atoms, and examples thereof include a phenyloxycarbonyl group and the like), an acyloxy group (having preferably 2 to 20 carbon atoms, more preferably 2 to 16 carbon atoms, and particularly preferably 2 to 10 carbon atoms, and examples thereof include an acetoxy group, a benzoyloxy group, and the like), an acylamino group (having preferably 2 to 20 carbon atoms, more preferably 2 to 16 carbon atoms, and particularly preferably 2 to 10 carbon atoms, and examples thereof include an acetylamino group, a benzoylamino group, and the like), an alkoxycarbonylamino group (having preferably 2 to 20 carbon atoms, more preferably 2 to 16 carbon atoms, and particularly preferably 2 to 12 carbon atoms, and examples thereof include a methoxycarbonylamino group and the like), an aryloxycarbonylamino group (having preferably 7 to 20 carbon atoms, more preferably 7 to 16 carbon atoms, and particularly preferably 7 to 12 carbon atoms, and examples thereof include a phenyloxycarbonylamino group, and the like), a sulfonylamino group (having preferably 1 to 20 carbon atoms, more preferably 1 to 16 carbon atoms, and particularly preferably 1 to 12 carbon atoms, and examples thereof include a methanesulfonylamino, a benzenesulfonylamino, and the like), a sulfamoyl group (having preferably 0 to 20 carbon atoms, more preferably 0 to 16 carbon atoms, and particularly preferably 0 to 12 carbon atoms, and examples thereof include a sulfamoyl group, a methylsulfamoyl group, a dimethylsulfamoyl group, a phenylsulfamoyl group, and the like), a carbamoyl group (having preferably 1 to 20 carbon atoms, more preferably 1 to 16 carbon atoms, and particularly preferably 1 to 12 carbon atoms, and examples thereof include a carbamoyl group, a methylcarbamoyl group, a diethylcarbamoyl group, a phenylcarbamoyl group, and the like), an alkylthio group (having preferably 1 to 20 carbon atoms, more preferably 1 to 16 carbon atoms, and particularly preferably 1 to 12 carbon atoms, and examples thereof include a methylthio group, an ethylthio group, and the like), an arylthio group (having preferably 6 to 20 carbon atoms, more preferably 6 to 16 carbon atoms, and particularly preferably 6 to 12 carbon atoms, and examples thereof include a phenylthio group and the like), a sulfonyl group (having preferably 1 to 20 carbon atoms, more preferably 1 to 16 carbon atoms, and particularly preferably 1 to 12 carbon atoms, and examples thereof include a mesyl group, a tosyl group, and the like), a sulfinyl group (having preferably 1 to 20 carbon atoms, more preferably 1 to 16 carbon atoms, and particularly preferably 1 to 12 carbon atoms, and examples thereof include a methanesulfinyl group, a benzenesulfinyl group, and the like), a ureido group (having preferably 1 to 20 carbon atoms, more preferably 1 to 16 carbon atoms, and particularly preferably 1 to 12 carbon atoms, and examples thereof include a ureido group, a methylureido group, a phenylureido group, and the like), a phosphoramide group (having preferably 1 to 20 carbon atoms, more preferably 1 to 16 carbon atoms, and particularly preferably 1 to 12 carbon atoms, and examples thereof include a diethylphosphoramide group, a phenylphosphoramide group, and the like), a hydroxy group, a mercapto group, a halogen atom (for example, a fluorine atom, a chlorine atom, a bromine atom and an iodine atom), a cyano group, a sulfo group, a carboxyl group, a nitro group, a hydroxamic acid, a sulfino group, a hydrazine group, an imino group, a heterocyclic group (having preferably 1 to 30 carbon atoms, and more preferably 1 to 12 carbon atoms, including, for example, a nitrogen atom, an oxygen atom, and a sulfur atom as a hetero atom, and specific examples thereof include an imidazolyl group, a pyridyl group, a quinolyl group, a furyl group, a piperidyl group, a morpholino group, a benzoxazolyl group, a benzimidazolyl group, a benzothiazolyl group, and the like), and a silyl group (having preferably 3 to 40 carbon atoms, more preferably 3 to 30 carbon atoms, and particularly preferably 3 to 24 carbon atoms, and examples thereof include a trimethylsilyl group, a triphenylsilyl group, and the like). These substituents may be further substituted. In addition, in a case in which there are two or more substituents, the substituents may be the same or different. In addition, in possible cases, the substituents may be coupled to each other so as to form a ring.

The aromatic group is defined as an aromatic compound as on Page 1208 in the 4^{th} edition of Physics and Chemistry Dictionary (Iwanami Shoten, Publishers). The aromatic group in the invention may be an aromatic hydrocarbon group or an aromatic heterocyclic group, and is more preferably an aromatic hydrocarbon group.

The aromatic hydrocarbon group has preferably 6 to 24 hydrogen atoms, more preferably 6 to 12 hydrogen atoms, and most preferably 6 to 10 hydrogen atoms. Specific examples of the aromatic hydrocarbon group include a phenyl group, a naphthyl group, an anthryl group, a biphenyl group, a terphenyl group, and the like, and the aromatic hydrocarbon group is more preferably a phenyl group. The aromatic hydrocarbon group is particularly preferably a phenyl group, a naphthyl group, or a biphenyl group. The aromatic heterocyclic group preferably includes at least one of an oxygen atom, a nitrogen atom, or a sulfur atom. Specific examples of the heterocycle include furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetrazaindene, and the like. The aromatic hetorocyclic group is particularly preferably a pyridyl group, a triazinyl group, or a quinolyl group.

Preferable examples of the acyl group (substituent A) including the aromatic group include a phenylacetyl group, a hydrocinnamoyl group, a diphenylacetyl group, a phenoxyacetyl group, a benzyloxyacetyl group, an O-acetylmandelyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisoyl group, a p-anisoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropioxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, a 4′-octyloxy-4-biphenylcarbonyl group, a piperonyloyl group, a diphenylacetyl group, a triphenylacetyl group, a phenylpropionyl group, a hydrocinnamoyl group, an α-methylhydrocinnamoyl group, a 2,2-diphenylpropionyl group, a 3,3-diphenylpropionyl group, a 3,3,3-triphenylpropionyl group, a 2-phenylbutyryl group, a 3-phenylbutyryl group, a 4-phenylbutyryl group, a 5-phenylvaleryl group, a 3-methyl-2-phenylvaleryl group, a 6-phenylhexanoyl group, an α-methoxyphenylacetyl group, a phenoxyacetyl group, a 3-phenoxypropionyl group, a 2-phenoxypropionyl group, a 11-phenoxydecanoyl group, a 2-phenoxybutyryl group, a 2-methoxyacetyl group, a 3-(2-methoxyphenyl)propionyl group, a 3-(p-toluyl)propionyl group, a (4-methylphenoxy)acetyl group, a 4-isobutyl-α-methylphenylacetyl group, a 4-(4-methoxyphenyl)butyryl group, a (2,4-di-tert-pentylphenoxy)-acetyl group, a 4-(2,4-di-tert-pentylphenoxy)-butyryl group, a (3,4-dimethoxyphenyl)acetyl group, a 3,4-(methylenedioxy)phenylacetyl group, a 3-(3,4-dimethoxyphenyl)propionyl group, a 4-(3,4-dimethoxyphenyl)butyryl group, a (2,5-dimethoxyphenyl)acetyl group, a (3,5-dimethoxyphenyl)acetyl group, a 3,4,5-trimethoxyphenylacetyl group, a 3-(3,4,5-trimethoxyphenyl)-propionyl group, an acetyl group, a 1-naphthylacetyl group, a 2-naphthylacetyl group, an α-trityl-2-naphthalene-propionyl group, a (1-naphthoxy)acetyl group, a (2-naphthoxy)acetyl group, a 6-methoxy-α-methyl-2-naphthaleneacetyl group, a 9-fluoreneacetyl group, a 1-pyreneacetyl group, a 1-pyrenebutyryl group, a γ-oxo-pyrenebutyryl group, a styreneacetyl group, an α-methylcinnamoyl group, an α-phenylcinnamoyl group, a 2-methylcinnamoyl group, a 2-methoxycinnamoyl group, a 3-methoxycinnamoyl group, a 2,3-dimethoxycinnamoyl group, a 2,4-dimethoxycinnamoyl group, a 2,5-dimethoxycinnamoyl group, a 3,4-dimethoxycinnamoyl group, a 3,5-dimethoxycinnamoyl group, a 3,4-(methylenedioxy)cinnamoyl group, a 3,4,5-trimethoxycinnamoyl group, a 2,4,5-trimethoxycinnamoyl group, a 3-methylidene-2-carbonyl group, a 4-(2-cyclohexyloxy)benzoyl group, a 2,3-dimethylbenzoyl group, a 2,6-dimethylbenzoyl group, a 2,4-dimethylbenzoyl group, a 2,5-dimethylbenzoyl group, a 3-methoxy-4-methylbenzoyl group, a 3,4-diethoxybenzoyl group, an α-phenyl-O-toluyl group, a 2-phenoxybenzoyl group, a 2-benzoylbenzoyl group, a 3-benzoylbenzoyl group, a 4-benzoylbenzoyl group, a 2-ethoxy-1-naphthoyl group, a 9-fluorenecarbonyl group, a 1-fluorenecarbonyl group, a 4-fluorenecarbonyl group, a 9-anthracenecarbonyl group, and a 1-pyrenecarbonyl group.

The substituent A is more preferably a phenylacetyl group, a hydrocinnamoyl group, a diphenylacetyl group, a phenoxyacetyl group, a benzyloxyacetyl group, an O-acetylmandelyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisoyl group, a p-anisoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropioxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 2,4,5-trimethoxybenzoyl group, a 3,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, or a 4′-octyloxy-4-biphenylcarbonyl group.

The substituent A is still more preferably a phenylacetyl group, a diphenylacetyl group, a phenoxyacetyl group, a cinnamoyl group, a 4-methoxy-cinnamoyl group, a benzoyl group, a phenylbenzoyl group, a 4-ethylbenzoyl group, a 4-propylbenzoyl group, a 4-tert-butylbenzoyl group, a 4-butylbenzoyl group, a 4-pentylbenzoyl group, a 4-hexylbenzoyl group, a 4-heptylbenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, or a 4-biphenylcarbonyl group.

The substituent A is still more preferably a benzoyl group, a phenylbenzoyl group, a 4-heptylbenzoyl group, a 2,4,5-trimethoxybenzoyl group, or a 3,4,5-trimethoxybenzoyl group.

The substituent A having the cellulose acylate may be one kind or two kinds.

The cellulose acylate may further have an acyl group other than the acyl group (substituent A) including the aromatic group, specifically, an aliphatic acyl group (substituent B).

Aliphatic Acyl Group (Substituent B)

The aliphatic acyl group (substituent B) in the invention may be an aliphatic acyl group having any of a linear, branched, and cyclic structure, and may be an aliphatic acyl group including an unsaturated bond. The aliphatic acyl group is an aliphatic acyl group having preferably 2 to 20 carbon atoms, more preferably 2 to 10 carbon atoms, and still more preferably 2 to 4 carbon atoms. Preferable examples of the substituent B include an acetyl group, a propionyl group, and a butyryl group, and, among the above, an acetyl group is preferable. When an acetyl group is included as the substituent B, a film having appropriate glass transition temperature (Tg), modulus of elasticity, and the like can be obtained. When having an aliphatic acyl group having a small number of carbon atoms, such as an acetyl group, the cellulose acylate can obtain an appropriate film strength without decreasing Tg, modulus of elasticity, and the like. The degree of substitution DSB of the substituent B is preferably 1.70 to 2.89, more preferably 1.70 to 2.80, and still more preferably 1.75 to 2.80. When the DSB is within the above range, the solubility can be maintained at a high level so that synthesis becomes easy, which is preferable.

Meanwhile, a plurality of kinds of aliphatic acyl groups may be included, and, in a case in which a plurality of kinds are included, the summed degree of substitution is used. The aliphatic acyl group is preferably one kind for synthesis.

Hereinafter, specific examples of cellulose acylate available in the invention will be described, but the cellulose acylate is not limited to the following examples.

The cellulose acylate is a compound having a cellulose skeleton obtained by biologically or chemically introducing at least the acyl group (substituent A) including the aromatic group using cellulose as a raw material.

As a raw material cotton of the cellulose acylate, not only a natural cellulose such as a cotton linter or a wood pulp (hardwood pulp or soft wood pulp) but also cellulose having a low degree of polymerization (a degree of polymerization of 100 to 300) obtained through hydrolysis of a wood pulp such as fine crystalline cellulose can be used, and a mixture thereof may be used according to necessary. Available raw material celluloses are described in detail in, for example, “Course of Plastic Materials (17): Cellulose Resins” (by Marusawa and Uda, published by The Nikkan Kogyo Shimbun, Ltd. (1970)) or Journal of Technical Disclosure, No. 2001-1745 (Pages 7 to 8) and “Cellulose Dictionary (Page 523)” (by The Cellulose Society of Japan, Asakura Publishing Co., Ltd., (2000)), but the raw material cotton is not particularly limited thereto.

The cellulose acylate used in the invention can be obtained through use of, for example, cellulose acetate manufactured by Sigma-Aldrich Co., LLC. (degree of acetyl substitution: 2.45) or cellulose acetate manufactured by Daicel Corporation (degree of acetyl substitution: 2.41 (product name: L-70), 2.19 (product name: FL-70), 1.76 (product name: LL-10)) as a starting raw material and a reaction with the corresponding acid chloride.

The average viscometric degree of polymerization of the cellulose acylate is not particularly limited, but is preferably 80 to 700, more preferably 90 to 500, and still more preferably 100 to 500. When the average degree of polymerization is set to 500 or less, there is a tendency for a film to become easily manufactured through tape casting without an excessive increase in the viscosity of a cellulose acylate-doped solution. In addition, when the degree of polymerization is set to 140 or more, the strength of a manufactured film further improves, which is preferable. The average degree of polymerization can be measured using a limiting viscosity method by Uda et al. (by Kazuo Uda and Hideo Saitoh, “Journal of the Society of Fiber Science and Technology, Japan” Vol. 18, Issue 1, Pages 105 to 120 (1962)). Specifically, the average degree of polymerization can be measured according to the method described in JP1997-95538A (JP-H09-95538A).

A cellulose acylate composition used to manufacture the optical film of the invention contains at least one kind of the cellulose acetate.

The cellulose acylate composition includes the cellulose acylate as a principle component in 50% by mass or more of the entire composition, preferably 70% by mass to 100% by mass, more preferably 80% by mass to 100% by mass, and still more preferably 90% by mass to 100% by mass.

The cellulose acylate composition may contain one selected from a variety of additives (for example, an ultraviolet inhibitor, a plasticizer, a deterioration inhibitor, fine particles, an optical characteristic adjuster, and the like) that can be generally added to cellulose acylate together with the cellulose acylate. In an aspect in which the optical film of the invention is formed using a solution film forming method, the additives may be added to the cellulose acylate at any point in time during a dope preparation process or at the end of a dope preparation process.

(2) Plasticizer

The cellulose acylate composition may or may not contain at least one kind of plasticizer. Examples of an available plasticizer include polyester-based polymers, styrene-based polymers, acryl-based polymers, copolymers thereof, and sugar ester compounds. Hereinafter, the respective plasticizers will be described.

Polyester-Based Polymer

The number average molecular weight of the polyester-based polymer in the invention is preferably 700 to less than 10000, more preferably 800 to 8000, still more preferably 800 to 5000, and particularly preferably 1000 to 5000. When the number average molecular weight is set within the above range, the compatibility improves.

The polyester-based polymer as the plasticizer is preferably a polymer obtained through a reaction between an aliphatic dicarboxylic acid having 2 to 20 carbon atoms or a mixture of an aliphatic dicarboxylic acid having 2 to 20 carbon atoms and an aromatic dicarboxylic acid having 8 to 20 carbon atoms, and at least one or more diols selected from an aliphatic diol having 2 to 12 carbon atoms, an alkyl ester diol having 4 to 20 carbon atoms, and an aromatic diol having 6 to 20 carbon atoms. The reactants may be used as a plasticizer as they are or after a blocking treatment in which both ends of the reactant are further reacted with a monocarboxylic acid, a monoalcohol, or a phenol. Removal of free carboxylic acids through the blocking of the ends is preferable from the viewpoint of preserving properties and the like.

A dicarboxylic acid residue constituting the polyester-based polymer is preferably an aliphatic dicarboxylic acid residue having 4 to 20 carbon atoms or an aromatic dicarboxylic acid residue having 8 to 20 carbon atoms.

Examples of the aliphatic dicarboxylic acid having 2 to 20 carbon atoms include oxalic acid, malonic acid, succinic acid, maleic acid, fumaric acid, glutaric acid, adipic acid, pimelic acid, suberic acid, azelaic acid, sebacic acid, dodecane dicarboxylic acid, and 1,4-cyclohexane dicarboxylic acid.

In addition, examples of the aromatic dicarboxylic acid having 8 to 20 carbon atoms include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid, 2,6-naphthalene dicarboxylic acid, and the like.

Among the above, the aliphatic dicarboxylic acid is preferably malonic acid, succinic acid, maleic acid, fumaric acid, glutaric acid, adipic acid, azelaic acid, or 1,4-cyclohexane dicarboxylic acid, and the aromatic dicarboxylic acid is preferably phthalic acid, terephthalic acid, isophthalic acid, 1,5-naphthalene dicarboxylic acid, or 1,4-naphthalene dicarboxylic acid. The aliphatic dicarboxylic acid is particularly preferably succinic acid, glutaric acid, or adipic acid, and the aromatic dicarboxylic acid is particularly preferably phthalic acid, terephthalic acid, or isophthalic acid.

A mixture obtained by combining at least one of each of the aliphatic dicarboxylic acids and the aromatic dicarboxylic acids is used to manufacture the polyester-based polymer, the combination is not particularly limited, and two or more of each of the respective dicarboxylic acids may be combined.

The diol is selected from aliphatic diols having 2 to 12 carbon atoms, alkyl ether diols having 4 to 20 carbon atoms, and aromatic diols having 6 to 20 carbon atoms.

The aliphatic diol having 2 to 20 carbon atoms can include alkyl diols and alicyclic diols, and examples thereof include ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol(neopentyl glycol), 2,2-diethyl-1,3-propanediol(3,3-dimethylolpentane), 2-n-butyl-2-ethyl-1,3 propanediol(3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, and the like. These glycols are used as a mixture of one or two or more.

Preferable examples of the aliphatic diol include ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, and 1,4-cyclohexanedimethanol, and particularly preferable examples thereof include ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol and 1,4-cyclohexanedimethanol

Preferable examples of the alkyl ether diol having 4 to 20 carbon atoms include polytetramethylene ether glycol, polyethylene ether glycol, polypropylene ether glycol, and combinations thereof. The average degree of polymerization is not particularly limited, but is preferably 2 to 20, more preferably 2 to 10, still more preferably 2 to 5, and particularly preferably 2 to 4. Examples thereof include a Carbowax resin, a Pluronics resin and a Niax resin as typically useful commercially available polyether glycols.

The aromatic diol having 6 to 20 carbon atoms is not particularly limited, examples thereof include bisphenol A, 1,2-hydroxybenzene, 1,3-hydroxybenzene, 1,4-hydroxybenzene, and 1,4-benzenedimethanol, and the aromatic diol is preferably bisphenol A, 1,4-hydroxybenzene, or 1,4-benzenedimethanol.

As described above, both ends of a reactant obtained through a reaction of the above components are preferably blocked, and a polyester-based polymer blocked with an alkyl group or an aromatic group at the ends is preferably used as a plasticizer. When both ends are protected using a hydrophobic functional group, hydrolysis of an ester group can be delayed so that it is possible to lessen deterioration over time in a high temperature and a high humidity.

Both ends of the polyester-based plasticizer are preferably protected using a monoalcohol residue or a monocarboxylic acid residue so as to prevent both ends from becoming a carboxylic acid or an OH group.

The monoalcohol that can be used for blocking is preferably a substituted or unsubstituted monoalcohol having 1 to 30 carbon atoms, and examples thereof include aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, and oleyl alcohol, and substituted alcohols such as benzyl alcohol and 3-phenyl-propanol.

Examples of an alcohol for blocking the ends which can be preferably used include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, and benzyl alcohol, and the alcohol is particularly preferably methanol, ethanol, propanol, isobutanol, cyclohexyl alcohol, 2-ethylhexyl alcohol, isononyl alcohol, and benzyl alcohol.

In addition, the monocarboxylic acid used for blocking is preferably a substituted or unsubstituted monocarboxylic acid having 1 to 30 carbon atoms. The monocarboxylic acid may be either an aliphatic monocarboxylic acid or an aromatic ring-containing monocarboxylic acid. Examples of a preferable aliphatic monocarboxylic acid include acetic acid, propionic acid, butanoic acid, caprylic acid, caproic acid, decanoic acid, dodecanoic acid, stearic acid, and oleic acid, and examples of the aromatic ring-containing monocarboxylic acids include benzoic acid, p-tert-butylbenzoic acid, p-tert-amylbenzoic acid, o-toluic acid, m-toluic acid, p-toluic acid, dimethylbenzoic acid, ethylbenzoic acid, n-propylbenzoic acid, aminobenzoic acid, acetoxybenzoic acid, and the like. One or two or more of the above may be used.

The polyester-based plasticizer can be easily synthesized through any of a heat-melt condensation method using a polyesterification reaction or an ester exchange reaction of the dicarboxylic acid component, the diol component, and the monocarboxylic acid or monoalcohol for blocking ends which are used as necessary and an interface condensation reaction of an acid chloride of the acid component and the glycol. The polyester-based plasticizer is described in detail in “Plasticizers—The Theory and Application Thereof” by Koichi Murai (Saiwai Shobo, the first edition, published on Mar. 1, 1973). In addition, it is also possible to use raw materials described in JP1993-155809A (JP-H05-155809A), JP1993-155810A (JP-H05-155810A), JP1993-197073A (JP-H05-197073A), JP2006-259494A, JP1995-330670A (JP-H07-330670A), JP2006-342227A, JP2007-003679A, and the like.

Hereinafter, specific examples of the polyester-based polymer that can be used in the invention will be described, but polyester-based polymers that can be used in the invention are not limited thereto.

TABLE 1

| | Dicarboxylic acid | | | Diol | | | Number |
|---|---|---|---|---|---|---|---|
| | Aromatic | Aliphatic | Dicarboxylic | | Diol | | average |
| | dicarboxylic | dicarboxylic | acid ratio | Aliphatic | ratio | | molecular |
| | acid | acid | (mol %) | diol | (mol %) | End | weight |
| P-1 | | AA | 100 | Ethanediol | 100 | Hydroxyl group | 1000 |
| P-2 | | AA | 100 | Ethanediol | 100 | Hydroxyl group | 2000 |
| P-3 | | AA | 100 | Propanediol | 100 | Hydroxyl group | 2000 |
| P-4 | | AA | 100 | Butanediol | 100 | Hydroxyl group | 2000 |
| P-5 | | AA | 100 | Hexanediol | 100 | Hydroxyl group | 2000 |
| P-6 | | AA/SA | 60/40 | Ethanediol | 100 | Hydroxyl group | 900 |
| P-7 | | AA/SA | 60/40 | Ethanediol | 100 | Hydroxyl group | 1500 |
| P-8 | | AA/SA | 60/40 | Ethanediol | 100 | Hydroxyl group | 1800 |
| P-9 | | SA | 100 | Ethanediol | 100 | Hydroxyl group | 1500 |
| P-10 | | SA | 100 | Ethanediol | 100 | Hydroxyl group | 2300 |
| P-11 | | SA | 100 | Ethanediol | 100 | Hydroxyl group | 6000 |
| P-12 | | SA | 100 | Ethanediol | 100 | Hydroxyl group | 1000 |
| P-13 | PA | SA | 50/50 | Ethanediol | 100 | Hydroxyl group | 1000 |
| P-14 | PA | SA | 50/50 | Ethanediol | 100 | Hydroxyl group | 1800 |
| P-15 | PA | AA | 50/50 | Ethanediol | 100 | Hydroxyl group | 2300 |
| P-16 | PA | SA/AA | 40/30/30 | Ethanediol | 100 | Hydroxyl group | 1000 |
| P-17 | PA | SA/AA | 50/20/30 | Ethanediol | 100 | Hydroxyl group | 1500 |
| P-18 | PA | SA/AA | 50/30/20 | Ethanediol | 100 | Hydroxyl group | 2600 |
| P-19 | TPA | SA | 50/50 | Ethanediol | 100 | Hydroxyl group | 1000 |
| P-20 | TPA | SA | 50/50 | Ethanediol | 100 | Hydroxyl group | 1200 |
| P-21 | TPA | AA | 50/50 | Ethanediol | 100 | Hydroxyl group | 2100 |
| P-22 | TPA | SA/AA | 40/30/30 | Ethanediol | 100 | Hydroxyl group | 1000 |
| P-23 | TPA | SA/AA | 50/20/30 | Ethanediol | 100 | Hydroxyl group | 1500 |
| P-24 | TPA | SA/AA | 50/30/20 | Ethanediol | 100 | Hydroxyl group | 2100 |
| P-25 | PA/TPA | AA | 15/35/50 | Ethanediol | 100 | Hydroxyl group | 1000 |
| P-26 | PA/TPA | AA | 20/30/50 | Ethanediol | 100 | Hydroxyl group | 1000 |
| P-27 | PA/TPA | SA/AA | 15/35/20/30 | Ethanediol | 100 | Hydroxyl group | 1000 |
| P-28 | PA/TPA | SA/AA | 20/30/20/30 | Ethanediol | 100 | Hydroxyl group | 1000 |
| P-29 | PA/TPA | SA/AA | 10/50/30/10 | Ethanediol | 100 | Hydroxyl group | 1000 |
| P-30 | PA/TPA | SA/AA | 5/45/30/20 | Ethanediol | 100 | Hydroxyl group | 1000 |
| P-31 | — | AA | 100 | Ethanediol | 100 | Acetyl ester | 1000 |
| | | | | | | residue | |
| P-32 | — | AA | 100 | Ethanediol | 100 | Acetyl ester | 2000 |
| | | | | | | residue | |
| P-33 | — | AA | 100 | Propanediol | 100 | Acetyl ester | 2000 |
| | | | | | | residue | |
| P-34 | — | AA | 100 | Butanediol | 100 | Acetyl ester | 2000 |
| | | | | | | residue | |
| P-35 | — | AA | 100 | Hexanediol | 100 | Acetyl ester | 2000 |
| | | | | | | residue | |
| P-36 | — | AA/SA | 60/40 | Ethanediol | 100 | Acetyl ester | 900 |
| | | | | | | residue | |

TABLE 2

| | Dicarboxylic acid | | | Diol | | | Number |
|---|---|---|---|---|---|---|---|
| | Aromatic | Aliphatic | Dicarboxylic | | Diol | | average |
| | dicarboxylic | dicarboxylic | acid ratio | Aliphatic | ratio | | molecular |
| | acid | acid | (mol %) | diol | (mol %) | End | weight |
| P-37 | — | AA/SA | 60/40 | Ethanediol | 100 | Acetyl ester | 1000 |
| | | | | | | residue | |
| P-38 | — | AA/SA | 60/40 | Ethanediol | 100 | Acetyl ester | 2000 |
| | | | | | | residue | |
| P-39 | — | SA | 100 | Ethanediol | 100 | Acetyl ester | 1000 |
| | | | | | | residue | |
| P-40 | — | SA | 100 | Ethanediol | 100 | Acetyl ester | 3000 |
| | | | | | | residue | |
| P-41 | — | SA | 100 | Ethanediol | 100 | Acetyl ester | 5500 |
| | | | | | | residue | |
| P-42 | — | SA | 100 | Ethanediol | 100 | Acetyl ester | 1000 |
| | | | | | | residue | |
| P-43 | PA | SA | 50/50 | Ethanediol | 100 | Acetyl ester | 1000 |
| | | | | | | residue | |
| P-44 | PA | SA | 50/50 | Ethanediol | 100 | Acetyl ester | 1500 |
| | | | | | | residue | |
| P-45 | PA | AA | 50/50 | Ethanediol | 100 | Acetyl ester | 1000 |
| | | | | | | residue | |
| P-46 | PA | SA/AA | 40/30/30 | Ethanediol | 100 | Acetyl ester | 1000 |
| | | | | | | residue | |
| P-47 | PA | SA/AA | 33/33/34 | Ethanediol | 100 | Benzoic acid | 1000 |
| P-48 | PA | SA/AA | 50/20/30 | Ethanediol | 100 | Acetyl ester | 1500 |
| | | | | | | residue | |
| P-49 | PA | SA/AA | 50/30/20 | Ethanediol | 100 | Acetyl ester | 2000 |
| | | | | | | residue | |
| P-50 | TPA | SA | 50/50 | Ethanediol | 100 | Acetyl ester | 1000 |
| | | | | | | residue | |
| P-51 | TPA | SA | 50/50 | Ethanediol | 100 | Acetyl ester | 1500 |
| | | | | | | residue | |
| P-52 | TPA | SA | 45/55 | Ethanediol | 100 | Acetyl ester | 1000 |
| | | | | | | residue | |
| P-53 | TPA | AA | 50/50 | Ethanediol | 100 | Acetyl ester | 2200 |
| | | | | | | residue | |
| P-54 | TPA | SA | 35/65 | Ethanediol | 100 | Acetyl ester | 1000 |
| | | | | | | residue | |
| P-55 | TPA | SA/AA | 40/30/30 | Ethanediol | 100 | Acetyl ester | 1000 |
| | | | | | | residue | |
| P-56 | TPA | SA/AA | 50/20/30 | Ethanediol | 100 | Acetyl ester | 1500 |
| | | | | | | residue | |
| P-57 | TPA | SA/AA | 50/30/20 | Ethanediol | 100 | Acetyl ester | 2000 |
| | | | | | | residue | |
| P-58 | TPA | SA/AA | 20/20/60 | Ethanediol | 100 | Acetyl ester | 1000 |
| | | | | | | residue | |
| P-59 | PA/TPA | AA | 15/35/50 | Ethanediol | 100 | Acetyl ester | 1000 |
| | | | | | | residue | |
| P-60 | PA/TPA | AA | 25/25/50 | Ethanediol | 100 | Acetyl ester | 1000 |
| | | | | | | residue | |
| P-61 | PA/TPA | SA/AA | 15/35/20/30 | Ethanediol | 100 | Acetyl ester | 1000 |
| | | | | | | residue | |
| P-62 | PA/TPA | SA/AA | 20/30/20/30 | Ethanediol | 100 | Acetyl ester | 1000 |
| | | | | | | residue | |
| P-63 | PA/TPA | SA/AA | 10/50/30/10 | Ethanediol | 100 | Acetyl ester | 1000 |
| | | | | | | residue | |
| P-64 | PA/TPA | SA/AA | 5/45/30/20 | Ethanediol | 100 | Acetyl ester | 1000 |
| | | | | | | residue | |
| P-65 | PA/TPA | SA/AA | 5/45/20/30 | Ethanediol | 100 | Acetyl ester | 1000 |
| | | | | | | residue | |
| P-66 | IPA | AA/SA | 20/40/40 | Ethanediol | 100 | Acetyl ester | 1000 |
| | | | | | | residue | |
| P-67 | 2,6-NPA | AA/SA | 20/40/40 | Ethanediol | 100 | Acetyl ester | 1200 |
| | | | | | | residue | |
| P-68 | 1,5-NPA | AA/SA | 20/40/40 | Ethanediol | 100 | Acetyl ester | 1200 |
| | | | | | | residue | |
| P-69 | 1.4-NPA | AA/SA | 20/40/40 | Ethanediol | 100 | Acetyl ester | 1200 |
| | | | | | | residue | |
| P-70 | 1,8-NPA | AA/SA | 20/40/40 | Ethanediol | 100 | Acetyl ester | 1200 |
| | | | | | | residue | |
| P-71 | 2,8-NPA | AA/SA | 20/40/40 | Ethanediol | 100 | Acetyl ester | 1200 |
| | | | | | | residue | |

In Tables 1 and 2, PA represents phthalic acid, TPA represents terephthalic acid, IPA represents isophthalic acid, AA represents adipic acid, SA represents succinic acid, 2,6-NPA represents, 2,6-naphthalene dicarboxylic acid, 2,8-NPA represents 2,8-naphthalene dicarboxylic acid, 1,5-NPA represents 1,5-naphthalene dicarboxylic acid, 1,4-NPA represents 1,4-naphthalene dicarboxylic acid, and 1,8-NPA represents 1,8-naphthalene dicarboxylic acid, respectively.

Styrene-Based Polymer

Examples of the plasticizer that can be used in the invention include styrene-based polymers. The number average molecular weight of the styrene-based polymer is preferably 700 to less than 100000, more preferably 800 to 50000, still more preferably 800 to 30000, and particularly preferably 1000 to 20000.

Examples of the styrene-based polymer include polymers having a structural unit obtained from an aromatic vinyl-based monomer represented by the following formula (1).

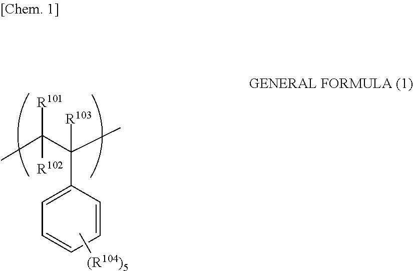

In the formula, R¹⁰¹ to R¹⁰⁴ represent a substituted or unsubstituted hydrocarbon group or polar group having 1 to 30 carbon atoms which may have a linking group including a hydrogen atom, a halogen atom, an oxygen atom, a sulfur atom, a nitrogen atom, or a silicon atom respectively, and R¹⁰⁴ may also form a carbon ring or a heterocycle (the carbon ring and the heterocycle may have a single ring structure, or form a multi-ring structure through condensation of other rings) through mutual bonding of the atoms or the groups which may be the same or different respectively.

Specific examples of the aromatic vinyl-based monomer that constitutes the styrene-based polymer include styrene; alkyl-substituted styrenes such as α-methylstyrene, β-methylstyrene, and p-methylstyrene; halogen-substituted styrenes such as 4-chlorostyrene and 4-bromostyrene; hydroxystyrenes such as p-hydroxystyrene, α-methyl-p-hydroxystyrene, 2-methyl-4-hydroxystyrene, and 3,4-dihydroxystyrene; vinyl benzyl alcohols; alkoxy-substituted styrenes such as p-methoxy styrene, p-tert-butoxystyrene, and m-tert-butoxystyrene; vinylbenzoic acids such as 3-vinylbenzoic acid and 4-vinylbenzoic acid; vinylbenzoic acid esters such as methyl-4-vinyl benzoate and ethyl-4-vinyl benzoate; 4-vinylbenzyl acetate; 4-acetoxystyrene; amidostyrenes such 2-butylamidostyrene, 4-methylamidostyrene, and p-sulfonamidostyrene; aminostyrenes such as 3-aminostyrene, 4-aminostyrene, 2-isopropenylaniline, and vinylbenzyldimethylamine; nitrostyrenes such as 3-nitrostyrene and 4-nitrostyrene; cyanostyrenes such as 3-cyanostyrene and 4-cyanostyrene; vinylphenylacetonitrile; arylstyrenes such as phenylstyrene; and indenes, but the aromatic vinyl-based monomer is not limited thereto. The aromatic vinyl-based monomer may be a styrene-based polymer obtained through copolymerization of two or more kinds of monomers. Among the above, styrene and α-methylstyrene are preferable in terms of easy industrial procurement and inexpensive costs.

Acryl-Based Polymer

Examples of the plasticizer that can be used in the invention include acryl-based polymers. The number average molecular weight of the acryl-based polymer is preferably 1000 to less than 2000000, more preferably 5000 to 1000000, and still more preferably 8000 to 500000.

Examples of the acryl-based polymer include polymers having a structural unit obtained from an acrylic acid ester-based monomer represented by the following formula (2).

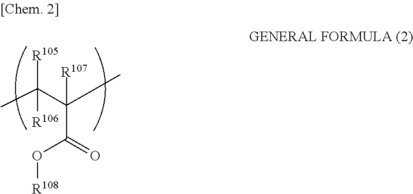

In the formula, R¹⁰⁵ to R¹⁰⁵ represent a substituted or unsubstituted hydrocarbon group or polar group having 1 to 30 carbon atoms which may have a linking group including a hydrogen atom, a halogen atom, an oxygen atom, a sulfur atom, a nitrogen atom, or a silicon atom respectively.

Examples of the acrylic acid ester-based monomer include methyl acrylate, ethyl acrylate, (i- or n-)propyl acrylate, (n-, s- or tert-)butyl acrylate, (n-, i- or s-)pentyl acrylate, (n- or i-)hexyl acrylate, (n- or i-)heptyl acrylate, (n- or i-)octyl acrylate, (n- or i-)nonyl acrylate, (n- or i-)myristyl acrylate), (2-ethylhexyl)acrylate, (ε-caprolactone)acrylate, (2-hydroxyethyl)acrylate, (2-hydroxypropyl)acrylate, (3-hydroxypropyl)acrylate, (4-hydroxybutyl)acrylate, (2-hydroxybutyl)acrylate, (2-methoxyethyl)acrylate, (2-ethoxyethyl)acrylate, phenyl acrylate, phenyl methacrylate, (2- or 4-chlorophenyl)acrylate, (2- or 4-chlorophenyl)methacrylate, (2-, 3- or 4-ethoxycarbonylphenyl)acrylate, (2-, 3- or 4-ethoxycarbonylphenyl)methacrylate, (o-, m- or p-tolyl)acrylate), (o-, m- or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, and the above in which the acrylic acid esters are converted into a methacrylic acid ester, but the acrylic acid ester-based monomer is not limited thereto. Two or more kinds of the monomers may be used as the copolymerization component. Among the above, methyl acrylate, ethyl acrylate, (i- or n-)propyl acrylate, (n-, s- or tert-)butyl acrylate, (n-, i- or s-)pentyl acrylate, (n- or i-)hexyl acrylate, and the above in which the acrylic acid esters are converted into a methacrylic acid ester are preferable in terms of easy industrial procurement and inexpensive costs.

Copolymer

The copolymer preferably includes at least one kind of structural unit obtained from an aromatic vinyl-based monomer represented by the general formula (1) and an acrylic acid ester-based monomer represented by the general formula (2).

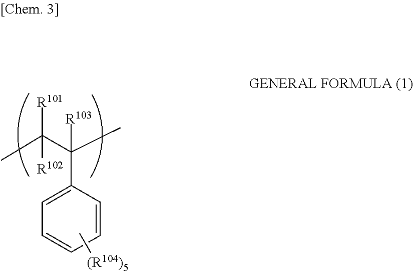

In the formula, R¹⁰¹ to R¹⁰⁴ represent a substituted or unsubstituted hydrocarbon group or polar group having 1 to 30 carbon atoms which may have a linking group including a hydrogen atom, a halogen atom, an oxygen atom, a sulfur atom, a nitrogen atom, or a silicon atom respectively, and R¹⁰⁴ may also form a carbon ring or a heterocycle (the carbon ring and the heterocycle may have a single ring structure, or form a multi-ring structure through condensation of other rings) through mutual bonding of the atoms or the groups which may be the same or different respectively.

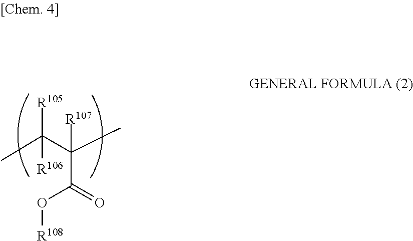

In the formula, R¹⁰⁵ to R¹⁰⁸ represent a substituted or unsubstituted hydrocarbon group or polar group having 1 to 30 carbon atoms which may have a linking group including a hydrogen atom, a halogen atom, an oxygen atom, a sulfur atom, a nitrogen atom, or a silicon atom respectively.

In addition, the acryl-based polymer may be a copolymer. A monomer that constitutes a copolymerization composition other than the above is preferably a monomer that easily forms a copolymer with the above monomer, and examples thereof include acid anhydrides such as maleic anhydride, citraconic anhydride, cis-1-cyclohexene-1,2-dicarboxylic anhydride, 3-methyl-cis-1-cyclohexene-1,2-dicarboxylic anhydride, and 4-methyl-cis-1-cyclohexene-1,2-dicarboxylic anhydride and nitrile group-containing radical polymerizable monomers such as acrylonitrile and methacrylonitrile; amide bond-containing radical polymerizable monomers such as acrylamide, methacrylamide, and trifluoromethanesulfonylaminoethyl(meth)acrylate; aliphatic vinyls such as vinyl acetate; chlorine-containing radical polymerizable monomers such as vinyl chloride and vinylidene chloride; and conjugated diolefins such as 1,3-butadiene, isoprene, and 1,4-dimethylbutadiene, but the monomer is not limited thereto.

The acryl-based polymer of the copolymer is particularly preferably a styrene-acrylic acid copolymer, a styrene-maleic anhydride copolymer, or a styrene-acrylonitrile copolymer.

Sugar Ester Compound

Examples of the plasticizer that can be used in the invention include sugar ester compounds. The number average molecular weight of the sugar ester compound is preferably 200 to 3500, more preferably 420 to 3000, and still more preferably 450 to 2000.

The sugar ester compound refers to a compound in which at least one functional group having a sugar residue or a sugar derivative residue (for example, a hydroxyl group or a carboxylic group) and at least one substituent form an ester bond. Examples of the derivative of the sugar include carboxylic acids such as gluconic acid obtained through oxidization of sugar. In a case in which the sugar ester compound includes a sugar residue, the functional group generally becomes a hydroxyl group. Meanwhile, in a case in which the sugar ester compound includes a sugar derivative residue such as gluconic acid, examples of the functional group also include carboxylic acid. That is, in the present specification, the “sugar ester compound” also includes compounds including a sugar derivative residue with a broad meaning, and, more specifically, the sugar ester compound also includes ester bodies of a sugar residue and a carboxylic acid and ester bodies of a sugar-derived carboxylic acid residue such as gluconic acid and an alcohol.

The functional group having the sugar residue or the sugar derivative residue that constitutes the sugar ester compound is preferably a hydroxyl group.

The sugar ester compound includes a polysaccharide-derived structure that constitutes the sugar ester compound (hereinafter referred to as the “sugar residue and the like” which indicates both the sugar residue and the sugar-derivative residue). The structure of the sugar residue and the like per sugar is referred to as the structural unit of the sugar ester compound. The structural unit of the sugar ester compound preferably includes a pyranose structural unit or a furanose structural unit, and all of the sugar residues are more preferably a pyranose structural unit or a furanose structural unit. In addition, in a case in which the sugar ester is constituted by polysaccharides, the structural unit preferably includes both the pyranose structural unit and the furanose structural unit.

The sugar residue and the like of the sugar ester compound may be derived from a pentasaccharide or a hexasaccharide, and is preferably derived from an hexasaccharide.

The number of the structural units included in the sugar ester compound is preferably 2 to 4, more preferably 2 to 3, and particularly preferably 2. That is, the sugar that constitutes the sugar ester compound is preferably di- to tetrasaccharide, more preferably disaccharide or trisaccharide, and particularly preferably a disaccharide.

In the invention, the sugar ester compound is preferably a sugar ester compound including 2 to 4 pyranose structural units or furanose structural units in which at least one hydroxyl group is esterified, and is more preferably a sugar ester compound including 2 pyranose structural units or furanose structural units in which at least one hydroxyl group is esterified.

Examples of monosaccharide or sugars including 2 to 4 monosaccharide units include erythrose, threose, ribose, arabinose, xylose, lyxose, allose, altrose, glucose, fructose, mannose, gulose, idose, galactose, talose, trehalose, intrehalose, neotrahalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, maltopentaose, verbascose, maltohexaose, xylitol, sorbitol, and the like.

The monosaccharide or sugars are preferably ribose, arabinose, xylose, lyxose, glucose, fructose, mannose, galactose, trehalose, maltose, cellobiose, lactose, sucrose, sucralose, xylitol, or sorbitol, are more preferably arabinose, xylose, glucose, fructose, mannose, galactose, maltose, cellobiose, sucrose, and are particularly preferably xylose, glucose, fructose, mannose, galactose, maltose, cellobiose, sucrose, xylitol, or sorbitol.

The sugar ester compound may have a substituent. Preferable examples of the substituent include an alkyl group (having preferably 1 to 22 carbon atoms, more preferably 1 to 12 carbon atoms, and particularly preferably 1 to 8 carbon atoms, and examples thereof include a methyl group, an ethyl group, a propyl group, a hydroxyethyl group, a hydroxypropyl group, 2-cyanoethyl group, a benzyl group, and the like), an acyl group (having preferably 6 to 24 carbon atoms, more preferably 6 to 18 carbon atoms, and particularly preferably 6 to 12 carbon atoms, and examples thereof include a phenyl group and a naphtyl group), an acyl group (having preferably 1 to 22 carbon atoms, more preferably 2 to 12 carbon atoms, and particularly preferably 2 to 8 carbon atoms, and examples thereof include an acetyl group, a propionyl group, a butyryl group, a pentanoyl group, a hexanoyl group, an octanoyl group, a benzoyl group, a toluyl group, a phthalyl group, and the like), an amide group (having preferably 1 to 22 carbon atoms, more preferably 2 to 12 carbon atoms, and particularly preferably 2 to 8 carbon atoms, and examples thereof include a formamido group, an acetamido group, and the like), and an imido group (having preferably 4 to 22 carbon atoms, more preferably 4 to 12 carbon atoms, and particularly preferably 4 to 8 carbon atoms, and examples thereof include a succinimido group, a phthalimido group, and the like). Among the above, the substituent is more preferably an alkyl group or an acyl group, still more preferably a methyl group, an acetyl group, a propionyl group, a butyryl group (among them, an i-butyryl group is preferable), a benzoyl group, particularly preferably includes at least one of an acetyl group and a butyryl group, and particularly preferably include only an acetyl group or both an acetyl group and a butyryl group.

Hereinafter, specific examples of the sugar ester compound that can be used in the invention will be described, but the sugar ester compound is not limited thereto. In addition, the following specific examples describe the degrees of ester substitution of the respective sugar ester compounds, but any sugar ester compound having any degree of substitution can be used as long as the sugar ester compound can serve as a plasticizer in the optical film of the invention. In addition, a sugar ester compound having a distribution of the degree of substitution may be used, and may be used as a mixture of two or more mutually different sugar ester compounds.

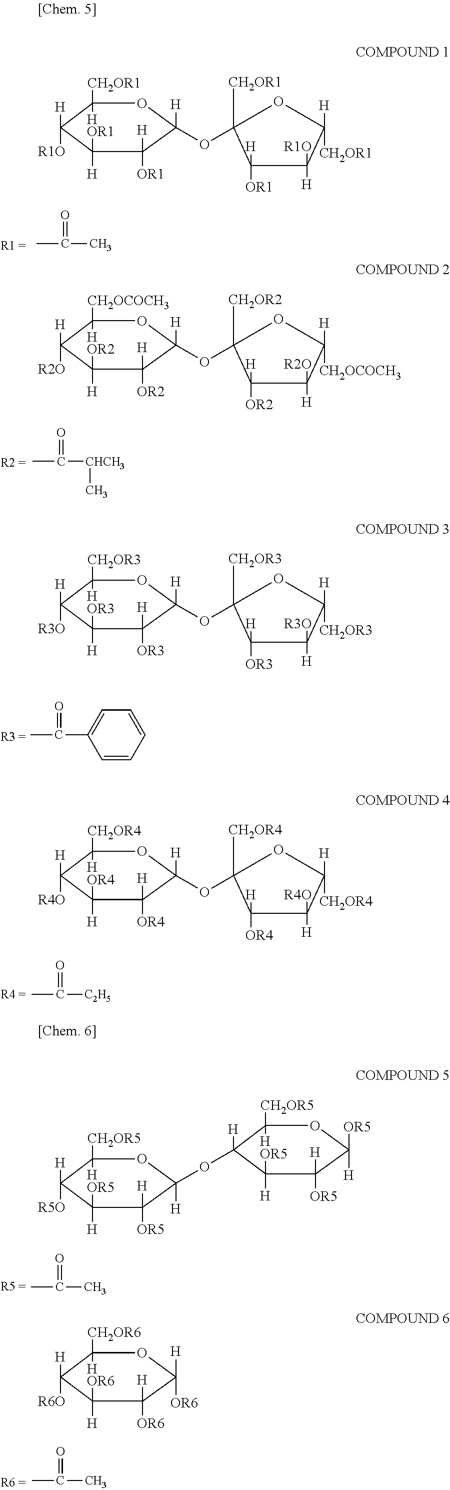

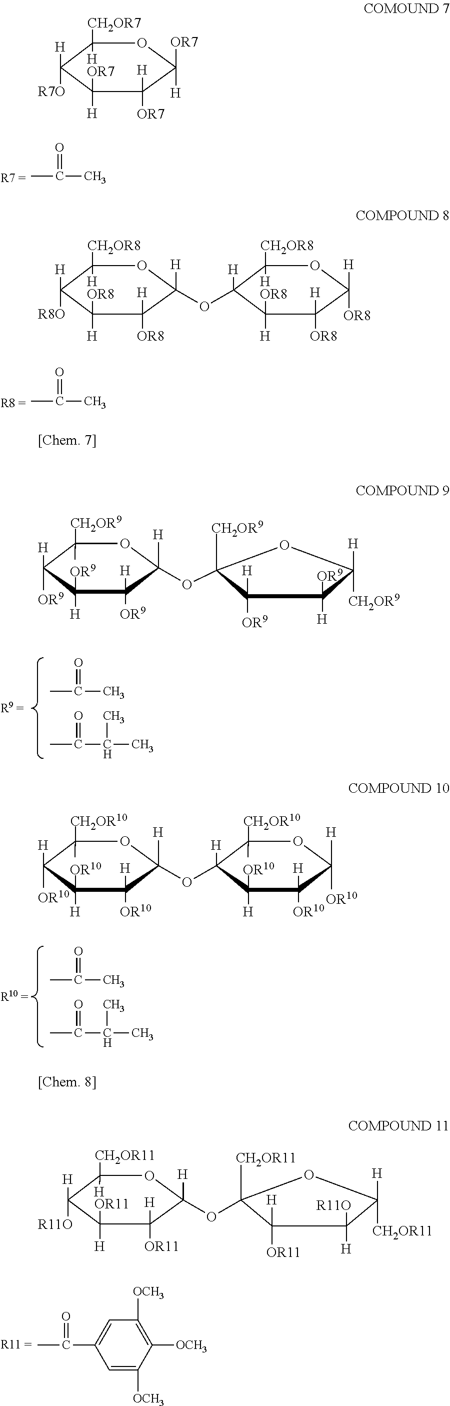

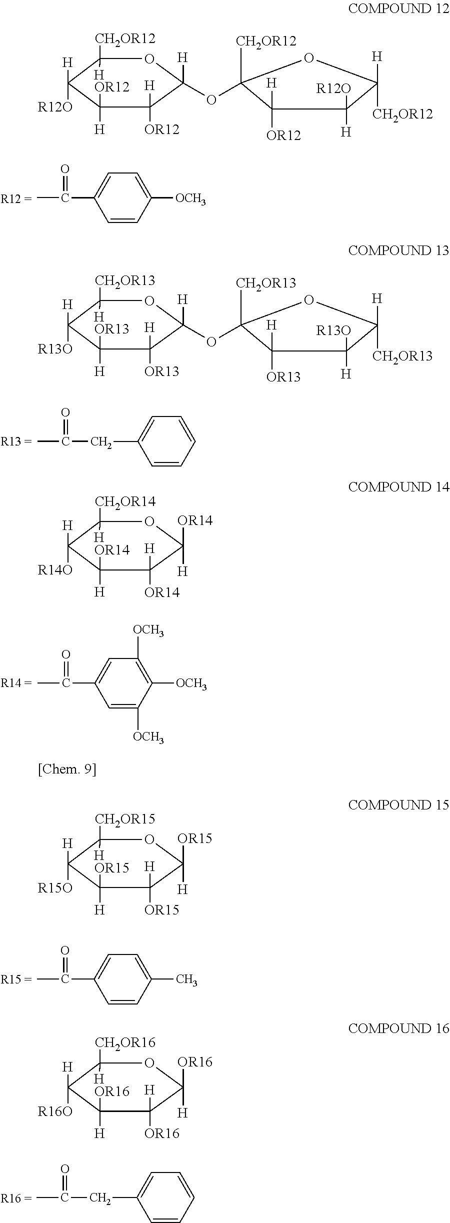

In the following structural formulae, R individually represents an arbitrary substituent respectively, and a plurality of Rs may be the same or different.

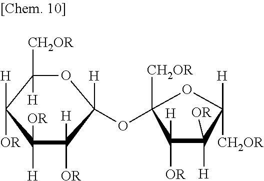

TABLE 3

| | Substituent 1 | | Substituent 2 | | |
|---|---|---|---|---|---|
| Com- | | Degree of | | Degree of | Molecular |
| pound | Kind | substitution | Kind | substitution | weight |
| 101 | Acetyl | 7 | Benzyl | 1 | 727 |
| 102 | Acetyl | 6 | Benzyl | 2 | 775 |
| 103 | Acetyl | 7 | Benzoyl | 1 | 741 |
| 104 | Acetyl | 6 | Benzoyl | 2 | 802 |
| 105 | Benzyl | 2 | None | 0 | 523 |
| 106 | Benzyl | 3 | None | 0 | 613 |
| 107 | Benzyl | 4 | None | 0 | 702 |
| 108 | Acetyl | 7 | Phenyl | 1 | 771 |
| | | | acetyl | | |
| 109 | Acetyl | 6 | Phenyl | 2 | 847 |
| | | | acetyl | | |
| 110 | Benzoyl | 1 | None | — | 446 |
| 111 | Benzoyl | 2 | None | — | 550 |
| 112 | Benzoyl | 3 | None | — | 654 |
| 113 | Benzoyl | 4 | None | — | 758 |
| 114 | Benzoyl | 5 | None | — | 862 |
| 115 | Benzoyl | 6 | None | — | 966 |
| 116 | Benzoyl | 7 | None | — | 1070 |
| 117 | Benzoyl | 8 | None | — | 1174 |
| 201 | Acetyl | 8 | None | 0 | 678 |
| 202 | Acetyl | 7 | i-Butyryl | 1 | 706 |
| 203 | Acetyl | 6 | i-Butyryl | 2 | 734 |
| 204 | Acetyl | 5 | i-Butyryl | 3 | 762 |
| 205 | Acetyl | 4 | i-Butyryl | 4 | 790 |
| 206 | Acetyl | 3 | i-Butyryl | 5 | 818 |
| 207 | Acetyl | 2 | i-Butyryl | 6 | 846 |
| 208 | Acetyl | 1 | i-Butyryl | 7 | 874 |
| 209 | Acetyl | 0 | i-Butyryl | 8 | 902 |

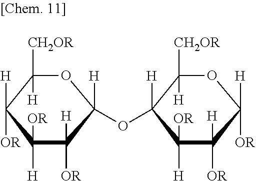

TABLE 4

| | Substituent 1 | | Substituent 2 | | |
|---|---|---|---|---|---|
| Com- | | Degree of | | Degree of | Molecular |
| pound | Kind | substitution | Kind | substitution | weight |
| 301 | Acetyl | 6 | Benzoyl | 2 | 803 |
| 302 | Acetyl | 6 | Benzyl | 2 | 775 |
| 303 | Acetyl | 6 | Phenyl | 2 | 831 |
| | | | acetyl | | |
| 304 | Benzoyl | 2 | None | 0 | 551 |
| 305 | Benzyl | 2 | None | 0 | 522 |
| 306 | Phenyl | 2 | None | 0 | 579 |
| | acetyl | | | | |

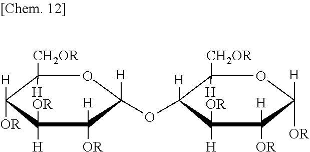

TABLE 5

| | Substituent 1 | | Substituent 2 | | |
|---|---|---|---|---|---|
| Com- | | Degree of | | Degree of | Molecular |
| pound | Kind | substitution | Kind | substitution | weight |
| 401 | Acetyl | 6 | Benzoyl | 2 | 803 |
| 402 | Acetyl | 6 | Benzyl | 2 | 775 |
| 403 | Acetyl | 6 | Phenyl | 2 | 831 |
| | | | acetyl | | |
| 404 | Benzoyl | 2 | None | 0 | 551 |
| 405 | Benzyl | 2 | None | 0 | 523 |
| 406 | Phenyl | 2 | None | 0 | 579 |
| | ester | | | | |

Additionally, as the sugar ester compound, it is also possible to use sugar ester compounds described in JP2001-247717A, JP2005-515285A, WO2007/125764A, WO2009/011228, WO2009/031464, and the like.

Regarding a method of procuring the sugar ester compound, the sugar ester compound can be commercially procured from commercially available products manufactured by Tokyo Chemical Industry Co., Ltd., Sigma-Aldrich Co. LLC., and the like, or can be synthesized by performing a known ester derivatization method (for example, a method described in JP1996-245678A (JP-H08-245678A)) on a commercially available carbohydrate.

(3) Method of Manufacturing an Optical Film

The method of manufacturing an optical film of the invention is not particularly limited, and the optical film may be manufactured using any of a solution film forming method and a melt film forming method. In addition, a drawing treatment or a biaxial drawing treatment is preferably carried out after film formation in order to satisfy characteristics required for the optical film of the invention.

An example of the method of manufacturing an optical film of the invention is a method of manufacturing a cellulose acylate film that satisfies the following formulae (I) and (II) which includes

a film-forming process in which a composition that includes cellulose acylate having an acyl group including an aromatic group as a principle component is formed into a film, and

a drawing process in which a drawing treatment is carried out on the obtained film,

in which the drawing treatment is carried out under a condition that the degree of cross-sectional orientation P2z of the drawn film satisfies the following formula (III)

150 nm≦Re (550)≦350 nm Formula (I)

−50 nm≦Rth (550)≦50 nm Formula (II)

0.07 nm≦degree of cross-sectional orientation P2z≦1 Formula (III)

Hereinafter, the above method will be described in detail.

Film Forming Process

In the film forming process, a film is formed using the cellulose acylate composition including cellulose acylate having an acyl group including an aromatic group as a principle component. A film is preferably formed using a solution film forming method. In the solution film forming method, a film is formed using a solution including cellulose acylate, a plasticizer and the like which are added as desired (hereinafter sometimes referred to as the “dope”). As a solvent used to prepare the dope, any solvent used to prepare a dope for solution tape casting in the past can be used, but a solvent selected from ethers having 3 to 12 carbon atoms, ketones having 3 to 12 carbon atoms, esters having 3 to 12 carbon atoms, and halogenated hydrocarbons having 1 to 6 carbon atoms is preferably used from the viewpoint of decreasing haze. The ethers, ketones, and esters may have a cyclic structure. A compound having two or more of any of functional groups (that is, —O—, —CO—, and —COO—) of an ether, a ketone, and an ester can also be used as the solvent. The solvent may have another functional group such as an alcoholic hydroxyl group. In the case of a solvent having two or more kinds of functional groups, the number of carbon atoms may be within the specified range of a compound having any of the functional groups.

Examples of the ethers having 3 to 12 carbon atoms include diisopropyl ether, dimethoxymethane, dimethoxy ethane, 1,4-dioxane, 1,3-dioxolane, tetrahydrofuran, anisole, and phenetole.

Examples of the ketones having 3 to 12 carbon atoms include acetone, methyl ethyl ketone, diethyl ketone, diisobutyl ketone, cyclohexanone, and methylcyclohexanone.

Examples of the esters having 3 to 12 carbon atoms include ethyl formate, propyl formate, pentyl formate, methyl acetate, ethyl acetate, and pentyl acetate.

Examples of an organic solvent having two or more kinds of functional groups include 2-ethoxyethyl acetate, 2-methoxy ethanol, and 2-butoxyethanol.

The number of carbon atoms in the halogenated hydrocarbon is preferably 1 or 2, and most preferably 1. The halogen in the halogenated hydrocarbon is preferably chlorine. The fraction of hydrogen atoms in the halogenated hydrocarbon substituted into halogens is preferably 25 mole % to 75 mole %, more preferably 30 mole % to 70 mole %, still more preferably 35 mole % to 65 mole %, and most preferably 40 mole % to 60 mole %. Examples of the halogenated hydrocarbons include dichloromethane, chloroform, methyl chloride, carbon tetrachloride, trichloroacetic acid, methyl bromide, methyl iodide, tri(tetra) chloroethylene, and the like, and the solvent preferably includes at least dichloromethane.

In the invention, a poor solvent is further included at a fraction of preferably 3% by weight to 30% by weight and more preferably 5% by weight to 20% by weight. When a poor solvent is included within the above range, the compatibility with cellulose acylate improves, and there is a tendency for haze to further decrease, which is preferable.

Furthermore, the boiling point of the poor solvent is preferably 120° C. or lower, and more preferably 40° C. to 100° C. When the boiling point is set to 120° C. or lower, the drying rate of the solvent can be further increased, which is preferable. Preferable examples of the poor solvent include methanol, ethanol, propanol, butanol, and water, and methanol is more preferable.

The dope can be prepared using an ordinary method. The ordinary method refers to a treatment at a temperature of 0° C. or higher (room temperature or a higher temperature). The solvent can be prepared using a method and an apparatus for preparing the dope in an ordinary solvent casting method. The dope can be prepared by stirring cellulose acylate and the solvent at room temperature (0° C. to 40° C.). A solution with a high concentration may be stirred under pressurization and heating conditions. Specifically, cellulose acylate and the solvent are fed into a pressurized vessel, blocked, and stirred while being heated to the boiling point or higher of the solvent at room temperature under pressurization and a temperature within a range in which the solvent does not boil. The heating temperature is generally 40° C. or higher, preferably 60° C. to 200° C., and more preferably 80° C. to 110° C.

The respective components may be coarsely mixed in advance, and then fed into a vessel (a tank or the like). In addition, the components may be sequentially fed into the vessel. The vessel needs to be configured so that the components can be stirred. The vessel can be pressurized by injecting an inert gas such as nitrogen gas. In addition, the vessel may be pressurized using an increase in the vapor pressure of the solvent through heating. Alternatively, the respective components may be added under pressure after the vessel is blocked.

In a case in which the components are heated, the vessel is preferably heated from outside. For example, it is possible to use a jacket-type heating apparatus. In addition, it is also possible to heat the entire vessel by providing a plate heater and pipes at the outside of the vessel, and circulating a liquid.

Stirring blades are preferably provided inside the vessel and used for stirring. The stirring blades preferably have a length that almost reaches the wall of the vessel. A scraping blade is preferably provided at the end of the stirring blade in order to renew a liquid film on the wall of the vessel.

The vessel may be provided with devices such as a manometer and a thermometer. The respective components are dissolved in the solvent in the vessel. The prepared dope is cooled and then removed from the vessel, or is removed and then cooled using a heat exchanger or the like.

It is also possible to prepare the dope using a cooling dissolution method.

As conditions and facilities used when solution film forming is carried out, the same solution tape casting film forming conditions and the same solution tape casting film forming apparatus as provided to manufacture a cellulose triacetate film of the related art are used. A dope (cellulose acylate solution) prepared from a dissolver (tank) is temporarily stored in a storage tank, and bubbles included in the dope are removed, thereby finally preparing the dope. A pressure die having a slit at the mouth portion whose shape can be adjusted so that a film can be easily formed into a uniform thickness is preferable. Typical examples of the pressure die include a coat-hanger die, a T die, and the like, and any of the above can be preferably used. The surface of a metal base forms a mirror surface. In order to increase the film forming rate, two or more pressure dies may be provided on the metal base, and the amount of the dope may be divided, thereby piling layers. Alternatively, it is also preferable that a laminate-structured film be obtained using a co-tape casting method in which a plurality of dopes are tape-cast at the same time.

It is preferable that the dope be sent to a pressurization-type die from a dope exhaust through, for example, a pressurization-type quantitative gear pump which can send liquid quantitatively at a high precision using the rotation rate, the dope be uniformly tape-cast on the metal base of a tape casting portion which runs endlessly from the mouth (slit) of the pressurization-type die, and a half-dry dope film (also referred to as a web) be peeled from the metal base at a peeling point at which the metal base almost runs one circuit. Both ends of the obtained web are pinched using clips, transported using a tenter, dried, subsequently, transported using a roll group of a drying apparatus, and completely dried, thereby winding the web into a predetermined length using a winding machine. The combination of the tenter and the roll group with the drying apparatus varies depending on the purposes. In a solution tape casting film forming method used for functional protective films of electronic displays, in addition to the solution tape casting film forming apparatus, a coating apparatus is often additionally provided in order for surface processes of an undercoat layer, an antistatic layer, an antihalation layer, a protective layer, and the like.

The prepared dope is preferably formed into a film by tape-casting on an endless metal base, for example, a metal drum or a metal base (a band or a belt), and evaporating the solvent. The concentration of the dope before the tape casting is preferably adjusted so that the amount of cellulose becomes 10% by mass to 35% by mass. The surface of the drum or band is preferably finished in a mirror surface state. The tape casting and drying methods in the solvent casting method are described in the respective specifications of U.S. Pat. No. 2,336,310A, U.S. Pat. No. 2,367,603A, U.S. Pat. No. 2,492,078A, U.S. Pat. No. 2,492,977A, U.S. Pat. No. 2,492,978A, U.S. Pat. No. 2,607704A, U.S. Pat. No. 2,739,069A, U.S. Pat. No. 2,739,070A, UK640731A, and UK736892A, JP1970-4554B (JP-S45-4554B), JP1974-5614B (JP-S49-5614B), JP1985-176834A (JP-S60-176834A), JP1985-203430A (JP-S60-203430A), and JP1987-115035 (JP-S62-115035).

Furthermore, in the invention, cellulose acylate film forming techniques described in JP2000-301555A, JP2000-301558A, JP1995-032391A (JP-H7-032391A), JP1991-193316A (JP-H3-193316A), JP1993-086212A (JP-H5-086212A), JP1987-037113A (JP-S62-037113A), JP1990-276607 (JP-H2-276607A), JP1980-014201A (JP-S55-014201A), JP1990-014201A (JP-H2-111511A), and JP1990-208650A (JP-H2-208650A) can be applied.

The dope is preferably tape-cast on a drum or band having a surface temperature of 30° C. or lower, and the temperature of the metal base is particularly preferably −50° C. to 20° C. In the manufacturing method of the invention, the dope tape-cast on the metal base is preferably hit by dried air from both rear and front surfaces of the metal base. The dope is preferably dried by being hit by air for two or more seconds after tape casting. An obtained film is peeled from the drum or band, and, furthermore, is dried using high-temperature air whose temperature changes sequentially from 100° C. to 160° C., whereby the residual solvent can be evaporated. The above method is described in JP1993-17844B (JP-H5-17844B). According to this method, the time from tape casting to peeling can be shortened. In order to carry out the method, the dope needs to gelate at the surface temperature of the drum or band during tape casting.

The film of the invention may be formed using a laminate tape casting method such as a co-tape casting method, a sequential tape casting method, or a coating method.

In the method, a drawing treatment is carried out after film formation. In an example, the dope tape-cast on the metal base is dried, the solvent is evaporated so as to produce a web, and then, the web is peeled at a peeling location. After peeling, a drawing process to be described below is preferably carried out. The peeled web is sent to the subsequent process using an arbitrary process. Meanwhile, when the residual volatile component (the following formula) of the web is too large at a point in time of peeling, the peeling becomes difficult, and, conversely, when the dope is sufficiently dried on the metal base and then peeled, some of the web is peeled in the middle.

Here, a gel tape casting method (gel casting) can be used as a method of increasing the film forming rate (the film forming rate can be increased by peeling the dope while the amount of the residual solvent is as large as possible). Examples thereof include a method in which a poor solvent is added to cellulose acylate in the dope, the dope is tape-cast, and then gelates, a method in which the dope is made to gelate by decreasing the temperature of the metal base, and the like. When the dope is made to gelate on the metal base so as to increase the strength of a film during peeling, the dope is peeled rapidly, and the film forming rate can be increased.

The amount of the residual solvent during peeling of the web on the metal base is preferably set in a range of 5% by mass to 150% by mass depending on the intensity of the drying conditions, the length of the metal base, and the like; however, in a case in which the dope is peeled at a point in time when the amount of the residual solvent is larger, the amount of the residual solvent during peeling is determined depending on the combination of the economic speed and quality. In the invention, the temperature at the peeling location on the metal base is preferably set to −50° C. to 40° C., more preferably 10° C. to 40° C., and still more preferably 15° C. to 30° C.

The method of drying the web that is dried on and peeled from the drum or belt will be described. A web peeled at a peeling location immediately before the drum or belt runs one circuit is preferably transported using a method in which the web is transported alternately through roll groups disposed in a zigzag shape, a method in which both ends of a peeled web are held using clips or the like, and transported in a non-contact manner, or the like.

The dope is dried using a method in which both surfaces of the web (film) being transported are hit by air having a predetermined temperature or a method in which heating means such as a microwave is used. Since abrupt drying may impair the flatness of a film to be formed, the dope is dried at a temperature at which the solvent does not release bubbles in the beginning phase of the drying, and then dried at a high temperature as the drying proceeds. In the drying process after the dope is peeled from the base, the film tends to shrink in the longitudinal direction (the transportation direction) or a direction orthogonal to the longitudinal direction (the width direction) due to evaporation of the solvent. The film shrinks more as the temperature of drying increases. The film is preferably dried while the shrinkage is suppressed as much as possible since the flatness of the completed film becomes favorable. Therefore, as described in JP1987-46625A (JP-S62-46625A), a method (a tenter method) in which all or some of the drying process is carried out in the width direction while both width ends of the web are held using clips or pins is preferable. In the drying process, the drying temperature is preferably 100° C. to 145° C. The drying temperature, the amount of dried air, and the drying time differ depending on the solvent being used, but may be appropriately selected depending on the kinds and combination of solvents being used.

Drawing Process

In the manufacturing method, the web obtained through film formation is drawn under a condition that the degree of cross-sectional orientation P2z of the drawn film satisfies the following formula (III).

0.07 nm≦degree of cross-sectional orientation P2z≦1 Formula (III)

A biaxial drawing treatment is preferably carried out. During the film forming process, the drawing may be carried out online, or may be carried out offline after completion of film formation and winding the film once. In the former case, the drawing may be carried out in a state in which the residual solvent is included, and the drawing can be preferably carried out with an amount of the residual solvent of 2% by mass to 50% by mass and preferably 5% by mass to 20% by mass. In addition, the drawing is preferably carried out at a drawing temperature of preferably (Tg−50° C.) to (Tg+50° C.), more preferably (Tg−30° C.) to (Tg+30° C.), and particularly preferably (Tg−20° C.) to (Tg+20° C.). Tg represents the glass transition temperature, and, specifically, can be specified to be a temperature at which the dynamic viscoelasticity tan δ of the film with 0% of the residual solvent shows a peak when tan δ is measured.

In the above method, the draw ratio r_{MD} in the MD direction and the draw ratio r_{TD} in the TD direction preferably satisfy r_{MD}<r_{TD}.

The draw ratio r_{MD} in drawing in the film-transporting direction is preferably 5% to 25%, and more preferably 5% to 15%.

Meanwhile, the “draw ratio (%)” mentioned herein is obtained using the following formula.

Draw ratio (%)=100×{(length after drawing)−(length before drawing)}/length before drawing

The method of drawing the web in the film-transporting direction is not particularly limited. Examples thereof include a method in which a plurality of rolls are rotated at different peripheral speeds, and the web is drawn in the vertical direction using the difference between the roll peripheral speeds, a method in which both ends of the web are fixed using clips or pins, and the interval between the clips or pins is widened in the traveling direction so as to draw the web in the vertical direction, a method in which the interval is widened vertically and horizontally at the same time so as to draw the web in both vertical and horizontal directions. Needless to say, a combination of the above methods may be used. In addition, in the case of the so-called tenter method, when the clip portions are driven in a linear drive mode, smooth drawing can be carried out so that the risk of rupture or the like can be decreased, which is preferable. The drawing in the vertical direction is preferably carried out in the following manner: an apparatus having two nip rolls is used, and the rotation speed of the nip roll at the exit side is made to be faster than the rotation speed of the nip roll at the entrance side so as to preferably draw a cellulose acylate film in the transportation direction (the vertical direction). The above drawing can adjust the development of retardation.

In the manufacturing method of the invention, the temperature T represents a temperature at which the drawing in the film-transporting direction or the direction orthogonal to the film-transporting direction satisfies the following formula (iii). The drawing temperature of any of the drawing in the film-transporting direction and the drawing in the direction orthogonal to the film-transporting direction may satisfy the following formula (iii); however, in the above manufacturing method, the drawing in the film-transporting direction and the drawing in the direction orthogonal to the film-transporting direction are both preferably carried out at the temperature T at which the following formula (iii) is satisfied.

Tg−50° C.≦drawing temperature T≦Tg+50° C. Formula (iii)

“Tg” in the formula (iii) is as described above.

For the drawing in the film-transporting direction, the drawing temperature T is preferably Tg−30° C. to Tg+30° C., and more preferably Tg−20° C. to Tg+20° C.

The draw ratio r_{TD} in the drawing in the direction orthogonal to the film-transporting direction is preferably 30% to 100%, and more preferably 45% to 85%.

The method of drawing the web in the direction orthogonal to the film-transporting direction is not particularly limited. Examples thereof include a method in which both ends of the web are fixed using clips or pins, and the interval between the clips or pins is widened in the traveling direction so as to draw the web in the horizontal direction, and a method in which the interval is widened vertically and horizontally at the same time so as to draw the web in both vertical and horizontal directions. Needless to say, a combination of the above methods may be used. In addition, in the case of the so-called tenter method, when the clip portions are driven in a linear drive mode, smooth drawing can be carried out so that the risk of rupture or the like can be decreased, which is preferable. In the invention, drawing using a tenter apparatus is preferable as the method of drawing the web in the direction orthogonal to the film-transporting direction.

For the drawing in the direction orthogonal to the film-transporting direction, the preferable range of the drawing temperature T is the same as the preferable range of the drawing temperature of the drawing in the film-transporting direction.

The drawing in the film-transporting direction and the drawing in the direction orthogonal to the film-transporting direction may be carried out sequentially or at the same time. Among the above, in the manufacturing method of the invention, the drawing in the film-transporting direction and the drawing in the direction orthogonal to the film-transporting direction is preferably carried out sequentially. In addition, the order of the drawings in a case in which the drawing in the film-transporting direction and the drawing in the direction orthogonal to the film-transporting direction is carried out sequentially is not particularly limited; however, in the manufacturing method of the invention, it is preferable that the drawing in the film-transporting direction be firstly carried out, and then the drawing in the direction orthogonal to the film-transporting direction be carried out since desired optical characteristics can be achieved.

In addition, JP2006-030962A and the like describe that the axial variation of an optical film is generally improved by increasing the draw ratio in the TD direction, and it is another merit of the biaxial drawing that the biaxial drawing which can increase the TD draw ratio compared to a uniaxial drawing when a desired Re is achieved can improve the axial variation of an obtained film, which is advantageous.

In addition, in a case in which the film is drawn in the film width direction, there are cases in which the refractive index becomes uneven in the width direction. This appears in a case in which, for example, the tenter method is used, and is considered to be a phenomenon occurring due to a fact that a contractile force is generated at the film center portion and the end portions are fixed, which is termed a so-called bowing phenomenon. Even in this case, when the film is drawn in the tape casting direction, the bowing phenomenon can be suppressed, and the distribution of the phase difference in the width direction can be improved slightly. Furthermore, the variation in the film thickness of a film obtained by drawing the web in biaxial directions which mutually intersect can be decreased. Particularly, in the case of a high Re such as the optical film of the invention, when the axial variation occurs or the phase difference becomes uneven in attaching the film to a liquid crystal display apparatus, the display characteristics significantly deteriorate; however, when the degree of cross-sectional orientation P2z is 0.07 to 1, and the sound speed ratio is 1.0 to 1.4, the deterioration is suppressed, which is advantageous. The degree of cross-sectional orientation P2z and the sound speed ratio can be adjusted within the above range through a biaxial drawing treatment (preferably a biaxial drawing treatment under the above conditions).

A film manufactured using the above method may have a long shape, and, after manufacturing, a long film may be wound for transportation, storage, and the like.

Winding

An ordinarily-used winding machine can be used as a winding machine that winds an obtained film, and the film can be wound using a winding method such as a constant tension method, a constant torque method, a taper tension method, or an internal stress-constant program tension control method. The slow axis direction of a cellulose acylate film obtained in the above manner is preferably ±2 degrees with respect to the winding direction (the longitudinal direction of the film), and more preferably in a range of ±1 degree. Alternatively, the slow axis direction is preferably ±2 degrees with respect to the right angle direction with respect to the winding direction (the width direction of the film), and more preferably in a range of ±1 degree. The slow axis direction of the film is particularly preferably within ±0.1 degrees with respect to the winding direction (the longitudinal direction of the film). Alternatively, the slow axis direction is preferably within ±0.1 degrees with respect to the width direction of the film.

Residual Volatile Component After Film Formation

A cellulose acylate film obtained using the above method of manufacturing a film of the invention preferably has a residual volatile component of a finally finished film of 1% by mass and more preferably 0.2% by mass.

Surface Treatment

In addition, there are cases in which the adhesion between the cellulose acylate film and the respective functional layers (for example, a primer layer and a back layer) can be improved by carrying out a surface treatment on the drawn cellulose acylate film. Examples of the surface treatment that can be used include a glow discharge treatment, an ultraviolet irradiation treatment, a corona treatment, a flame treatment, and an acid or alkali treatment.

(4) The Characteristics of the Optical Film

The Re and Rth of the optical film of the invention satisfy the following formulae (I) and (II).

150 nm Re≦(550)≦350 nm Formula (I)

−50 nm Rth≦(550)≦50 nm Formula (II)

In an aspect in which the optical film is used for the optical compensation of a liquid crystal display apparatus employing a horizontal orientation mode such as an IPS mode, the Re and Rth preferably satisfy the following formulae (I′) and (II′)

170 nm≦Re (550)≦330 nm Formula (I′)

−40 nm≦Rth (550)≦40 nm, and Formula (II′)

more preferably satisfy the following formulae (I″) and (II″)

200 nm≦Re (550)≦300 nm Formula (I″)

−30 nm≦Rth (550)≦5 30 nm. Formula (II″)

Meanwhile, in the specification, Re (λ) and Rth (λ) represent the in-plane retardation and the thickness-direction retardation at a wavelength of λ respectively. In the specification, the wavelength λ refers to 550 nm unless otherwise described. Re (λ) is measured by making a light ray with a wavelength of λ nm incident in a film normal direction in a KOBRA 21ADH or WR (manufactured by Oji Scientific Instruments). Re (λ) can be measured by exchanging wavelength-selecting filters manually or converting measured values using a program or the like when selecting a measurement wavelength λ nm.

In a case in which a film to be measured is a uniaxial or biaxial refractive index ellipsoid, Rth (λ) is computed using the following method.

Rth (λ) is obtained by making light rays with a wavelength of λ nm incident in inclined directions at 10 degree intervals from the normal direction to 50 degrees with respect to the film normal direction, considering the in-plane slow axes (determined using a KOBRA 21ADH or WR) as inclined axes (rotation axes) (in a case in which there is no slow axis, an arbitrary direction in a film plane is considered to be the rotation axis), measuring Re (λ) at a total of six points, and computing Rth (λ) based on the measured retardation values, the imaginary values of the average refractive index, and the inputted film thickness value using a KOBRA 21ADH or WR.

In the above method, in the case of a film having a direction in which the retardation value becomes zero at the inclined angle when the in-plane slow axis from the normal direction is considered to be a rotation axis, the retardation values at inclined angles that are larger than the inclined angle are changed to be negative values, and then Rth (λ) is computed using a KOBRA 21ADH or WR.

Further, it is also possible to obtain Rth (λ) by measuring retardation values from two arbitrarily inclined directions, considering the slow axes as inclined axes (rotation axes) (in a case in which there is no slow axis, an arbitrary direction in a film plane is considered to be the rotation axis), and computing Rth (λ) based on the values, the imaginary values of the average refractive index, and the inputted film thickness value using the following formulae (3) and (3′).

$$\begin{matrix}[ Formula 1 ] & \\ Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & FORMULA ( 3 )\end{matrix}$$

The above Re (θ) represents the retardation value in a direction inclined at an angle of θ from the normal direction.

nx in the formula (3) represents the refractive index in the slow axis direction in the plane, ny represents the refractive index in a direction orthogonal to nx in the plane, and nz represents the refractive index in a direction orthogonal to nx and ny. d is the film thickness.

Rth={(nx+ny)/2−nz}×d Formula (3′)

In a case in which a film to be measured is a subject that cannot be expressed with a uniaxial or biaxial refractive index ellipsoid, a so-called optic axis-free film, Rth (λ) is computed using the following method.

Rth (λ) is obtained by making light rays with a wavelength of λ nm incident in inclined directions at 10 degree intervals from −50 degrees to 50 degrees with respect to the film normal direction, considering the in-plane slow axes (determined using a KOBRA 21ADH or WR) as inclined axes (rotation axes), measuring Re (λ) at a total of eleven points, and computing Rth (λ) based on the measured retardation values, the imaginary values of the average refractive index, and the inputted film thickness value using a KOBRA 21ADH or WR.

In the above measurement, values from Polymer Handbook (John Wiley & Sons, Inc.) and catalogues of a variety of optical films can be used as the imaginary values of the average refractive index. For optical films for which the values of the average refractive index are not known, the values can be measured using an Abbe's refractometer. The values of the average refractive indexes of principle optical films will be exemplified below: cellulose acylate (1.48), cycloolefin polymer (1.52), polycarbonate (1.59), polymethyl methacrylate (1.49), and polystyrene (1.59). When the imaginary values of the average refractive indexes and a film thickness are inputted, nx, ny, and nz are computed using a KOBRA 21ADH or WR. From the computed nx, ny, and nz, Nz is further computed using Nz=(nx−nz)/(nx−ny).

Meanwhile, the in-plane slow axis of the cellulose acylate film of the invention may be in any of the longitudinal direction and the width direction.

In addition, in the optical film of the invention, the degree of cross-sectional orientation P2z satisfies the following formula (III),

0.07 nm≦degree of cross-sectional orientation P2z≦1. Formula (III)

Meanwhile, the degree of cross-sectional orientation P2z of the film is defined using the following formulae (1) and (2) which are computed from X-ray diffraction measurement.

P=<3 cos 2β−1>/2 (1)

P2z=(Pxz+Pyz)/2 (2)

However, <cos 2β>=∫(0, π)cos 2βI(β)sin βdβ/∫(0, π)sin βdβ

(In the formula, β represents the angle formed between the incident plane of an incident X-ray and an arbitrary direction of the film in-plane to be measured, and I represents the diffraction intensity at 2θ=7° to 11° in an X-ray diffraction chart measured at the angle of β.)

In addition, Pxz represents the degree of orientation defined using the above formula (1) which is obtained from the X-ray diffraction measurements in the film-forming direction of the film and the direction perpendicular to the out-plane direction, and Pyz represents the degree of orientation defined using the above formula (1) which is obtained from the X-ray diffraction measurements in the width direction of the film and the direction perpendicular to the out-plane direction. That is, the fact that the degree of cross-sectional orientation satisfies the range of the above formula (III) indicates a state in which the film is oriented in the in-plane direction rather than the out-plane direction.

Meanwhile, X-ray diffraction is measured through transmission two-dimensional X-ray measurement, in which an RINT RAPID manufactured by Rigaku Corporation is used, a Cu tube is used as an X-ray source, X-rays are generated at 40 kV-36 mA, the collimator is 0.8 mmφ, the film specimen is fixed using a transmission specimen table, and the exposure time is set to 600 seconds.

In addition, in the optical film of the invention, the ratio VT/VM between the sound velocity VM in a predetermined direction of a rectangular film and the sound velocity in a direction intersecting the predetermined direction is preferably 1.0 to 1.4.

Specifically, in a case in which the sound velocity in a direction parallel to an arbitrary side of the rectangular film and the sound velocity in the intersecting direction are compared, the sound velocity having an increasing value is considered to be VT, the sound velocity having a decreasing value is considered to be the sound velocity VM in the predetermined direction, and the ratio VT/VM of the sound velocities is preferably 1.0 to 1.4.

In a long film obtained through the continuous film formation of the invention, the sound velocity in the film formation and transportation direction which is the longitudinal direction becomes VM, and the sound velocity in the width direction which intersects the longitudinal direction becomes VT. A film having a ratio of the sound velocities in the above range can be easily manufactured through a biaxial stretching treatment. Meanwhile, the predetermined direction which corresponds to the sound velocity VM is preferentially the slow axis direction of the film.

Meanwhile, the sound velocity of a film in a predetermined direction can be measured by measuring the sound velocities in the longitudinal direction and the width direction in an atmosphere of 25° C. and 55% RH using a sound velocity measurement apparatus manufactured by Nomura Corporation Co., Ltd. “SST-110” and a film whose humidity has been adjusted for 24 hours or more in an atmosphere of 25° C. and 55% RH.

The thickness of the optical film of the invention is not particularly limited. Generally, the thickness of a film used in a liquid crystal display apparatus is approximately 10 μm to 150 μm, and the optical film of the invention also may have a thickness in the above range. Since Re is proportional with the thickness of the film, Re also increases as the thickness increases. The optical film of the invention can achieve Re that satisfies the above formula (I) even with a thickness of less than 80 μm and, furthermore, a thickness of 40 μm to 70 μm.

(5) Use of the Optical Film

Phase Difference Film

The optical film of the invention can be used as a phase difference film.

In addition, the functional layers described in detail in Pages 32 to 45 of Japan Institute of Invention and Innovation's Technical Reports (Report No. 2001-1745, published on Mar. 15, 2001 by Japan Institute of Invention and Innovation) are preferably included in the optical film of the invention. Among the above, supply of a polarizing film (formation of a polarizing plate), supply of an optical compensation layer consisting of a liquid crystal composition (an optical compensation film), and supply of an antireflection layer (an antireflection film) are preferable.

Optical Compensation Film

The optical film of the invention can be used for the optical compensation of a liquid crystal display apparatus. In a case in which the optical film of the invention satisfies optical characteristics necessary for optical compensation, the optical film can be used as an optical compensation film as it is. In addition, it is also possible to laminate the optical film of the invention with one or more additional layers, for example, an optical anisotropic layer formed by curing a liquid crystal composition or a layer consisting of other birefringent polymer film in order to satisfy optical characteristics necessary for optical compensation, and then use the film as an optical compensation film.

Antireflection Film

In addition, the invention also relates to an antireflection film having the optical film of the invention and an antireflection layer. The antireflection film can be manufactured based on an ordinary manufacturing method, and, for example, can be manufactured with reference to JP2006-241433A.

2. Polarizing Plate

The invention relates to a polarizing plate having at least the optical film of the invention and a polarizer. The optical film of the invention may be used as a polarizing plate protective film. A well-known polarizer of the related art can be used as the polarizer, and examples thereof include a polarizer obtained by treating a hydrophilic optical film such as a polyvinyl alcohol film using a dichromatic dye such as iodine and drawing the film. The method of attaching the optical film of the invention and the polarizer is not particularly limited, and the optical film and the polarizer can be attached using an adhesive consisting of an aqueous solution of a water-soluble polymer. A complete saponification-type polyvinyl alcohol aqueous solution is preferably used as the water-soluble polymer adhesive.

In addition, the polarizer may have a protective film on the other surface (the surface on the opposite side of the surface to which the optical film of the invention is attached). The protective film is not particularly limited, and may be a cellulose acylate film containing cellulose acylate as a principle component or a film containing other high molecular (which means inclusion of both a resin and a polymer) components. Examples of other high molecular component include polyolefin, polycarbonate, an acryl resin, and the like.

3. Liquid Crystal Display Apparatus

The invention relates to a liquid crystal display apparatus having the polarizing plate of the invention. The optical film of the invention is preferably disposed between the polarizer and a liquid crystal cell. The polarizing plate of the invention may be disposed on the surface of the liquid crystal cell on the observation side or on the surface on the back light side. The polarizing plate is preferably used in a liquid crystal display apparatus employing a horizontal orientation mode such as an IPS mode and an FFS mode.

### EXAMPLES

Hereinafter, the invention will be described more specifically using examples. Materials, the amount of use, fractions, treatment contents, treatment sequences, and the like shown in the following examples can be appropriately varied within the scope of the purport of the invention. Therefore, the scope of the invention is not limited to specific examples described below.

1. Synthesis of Cellulose Acrylates

Cellulose acrylates having a variety of substituents shown in Tables 6 and 7 were synthesized using the methods of saponification of cellulose acetate described in [0121] of JP2008-163193A and aromatic acylation of cellulose acetate described in [0124] of JP2008-163193A.

2. Manufacturing of a Cellulose Acylate Film

(1) Preparation of the Dope

Cellulose Acylate Solution 1

The respective solutions of the cellulose acrylates synthesized above were prepared using the following method.

The following composition was fed into a mixing tank, stirred so as to dissolve the respective components, furthermore, heated at 90° C. for approximately 10 minutes, and then filtered using a paper filter having an average pore diameter of 34 μm and a sintered metal filter having an average pore diameter of 10 μm.

### Cellulose Acylate Solution

Cellulose acylate (the kind and degree of substitution of the 100.0 parts by mass substituent A are described in the following table)

| | |
|---|---|
| Dichloromethane | 462.0 parts by mass |

Cellulose Acylate Solution 2

The following composition was fed into a mixing tank, stirred so as to dissolve the respective components, furthermore, heated at 90° C. for approximately 10 minutes, and then filtered using a paper filter having an average pore diameter of 34 μm and a sintered metal filter having an average pore diameter of 10 μm.

### Cellulose Acylate Solution

Cellulose acylate (the kind and degree of substitution of the 100.0 parts by mass substituent A are described in the following table)

| | |
|---|---|
| Dichloromethane | 401.9 parts by mass |
| Methanol | 60.1 parts by mass |

Cellulose Acylate Solution 3

The following composition was fed into a mixing tank, stirred so as to dissolve the respective components, furthermore, heated at 90° C. for approximately 10 minutes, and then filtered using a paper filter having an average pore diameter of 34 μm and a sintered metal filter having an average pore diameter of 10 μm.

### Cellulose Acylate Solution

Cellulose acylate (the kind and degree of substitution of the 91.0 parts by mass substituent A are described in the following table)

| | |
|---|---|
| Plasticizer (described in the table) | 9.0 parts by mass |
| Dichloromethane | 462.0 parts by mass |

(2) Tape Casting Film Formation

The cellulose acylate solutions described in Tables 6 and 7 were tape-cast using a metal band tape casting machine, dried, and then the film was peeled from the band using a peeling drum. In the above manner, non-drawn films were manufactured respectively.

(3) Drawing

Each of the non-drawn films manufactured above was drawn through fixed end uniaxial drawing in the film-transporting direction (MD) in a tenter zone at the temperature and draw ratio described in the following table. Next, at the same temperature, the film was drawn through fixed end uniaxial drawing in the width direction (TD) in a tenter zone at the temperature and draw ratio described in the following table. Biaxial drawing treatments were carried out in the above manner, and cellulose acylate films were manufactured respectively.

Meanwhile, the thickness of the tape-cast film was adjusted so that the thickness of the drawn and dried film became the film thickness described in the following table.

In addition, cellulose diacetate (DAC) films and polystyrene (PS) films were manufactured under the conditions described in the following table as reference example films.

2. Evaluation of the Optical Films

Optical Characteristics:

The in-plane retardation Re of each of the manufactured films was obtained through a 3-dimensional birefringence measurement at a wavelength of 550 nm using an automatic birefringence meter KOBRA-WR (manufactured by Oji Scientific Instruments) according to the above method, and the retardation Rth in the film thickness direction was obtained by measuring Re with varied inclination angles. The results are shown in the following table. Meanwhile, the slow axes of the films of the examples and the comparative examples were all in parallel with the longitudinal direction.

Degree of Cross-Sectional Orientation P2z:

The degree of cross-sectional orientation P2z of each of the manufactured films was measured using a RINT RAPID manufactured by Rigaku Corporation. The results are shown in the following table.

Sound Velocity Ratio:

The sound velocity VM in the longitudinal direction and the sound velocity VT in the width direction of each of the manufactured films were measured using a sound velocity measurement apparatus manufactured by Nomura Corporation Co., Ltd. “SST-110”, and the ratios of the sound velocities VT/VM were computed respectively. The results are shown in the following table.

3. Manufacturing of the Polarizing Plate

The drawn polyvinyl alcohol film was made to absorb iodine so as to manufacture a polarizer.

Each of the manufactured films was subjected to a saponification treatment, and attached to one side of the polarizer using a polyvinyl alcohol-based adhesive. The same saponification treatment was carried out on a commercially available cellulose triacylate film (FUJI TAC TD80UF, manufactured by Fuji Photo Film Co., Ltd.), and the saponification-treated cellulose triacetate film was attached to the surface of the polarizer on the opposite side to the side to which the manufactured film was attached using a polyvinyl alcohol-based adhesive.

At this time, the transmission axis of the polarizer and the slow axis of each of the respective films were disposed in parallel with each other. In addition, the transmission axis of the polarizer and the slow axis of the commercially available cellulose triacetate film were disposed orthogonally.

The respective polarizers were manufactured in the above manner.

4. Manufacturing and Evaluation of an IPS Mode Liquid Crystal Display Apparatus

(1) Manufacturing

Each of the obtained polarizing plates was attached to a panel so as to manufacture an IPS mode liquid crystal display apparatus for evaluation.

Specifically, the respective liquid crystal display apparatuses were manufactured by disposing the respective polarizing plates on the observation side of the liquid crystal panel so that the respective manufactured films were on the liquid crystal cell side with respect to an IPS mode liquid crystal display of a 37-type high vision liquid crystal television 37Z2000 manufactured by Toshiba Corporation from which the polarizing plate on the observation side was removed (hereinafter also referred to as the panel).

(2) Evaluation of Display Characteristics

The black luminance of each of the respective manufactured liquid crystal display apparatuses at an orientation angle at which light leakage in a polar angle 60° direction became the maximum was measured, and the display characteristics were evaluated based on the following display characteristics. The results are shown in the following table.

A: The black luminance was 1.5 cd/m² or less.

B: The black luminance was larger than 1.5 cd/m² and 5.0 cd/m² or less.

C: The black luminance was larger than 5.0 cd/m².

TABLE 6

| | | | | | | | | Drawing |
|---|---|---|---|---|---|---|---|---|
| | Cellulose | Aromatic acyl group | | Aliphatic acyl group | | | Film | temperature |
| | acylate | | Degree of | | Degree of | Kind of | thickness | [° C.] |
| | solution | Kind*1 | substitution | Kind*1 | substitution | additive*3 | [μm] | (ΔTg)*2 |
| Example 1 | 1 | Bz | 0.78 | Ac | 1.76 | — | 60 | −5 |
| Example 2 | 2 | Bz | 0.88 | Ac | 1.76 | — | 60 | −5 |
| Example 3 | 2 | Bz | 0.86 | Ac | 1.76 | — | 60 | −5 |
| Example 4 | 1 | Bz | 0.86 | Ac | 1.76 | — | 60 | −5 |
| Example 5 | 1 | Bz | 0.86 | Ac | 1.76 | — | 60 | −5 |
| Example 6 | 1 | Bz | 0.78 | Ac | 1.76 | — | 100 | −5 |
| Example 7 | 1 | Bz | 0.78 | Ac | 1.76 | — | 110 | −5 |
| Example 8 | 1 | Bz | 0.86 | Ac | 1.76 | — | 100 | −5 |
| Example 9 | 1 | Bz | 0.94 | Ac | 1.76 | — | 60 | −5 |
| Example | 1 | Bz | 1.21 | Ac | 1.76 | — | 60 | −5 |
| 10 | | | | | | | | |
| Example | 1 | Bz | 0.86 | Pr | 1.76 | — | 60 | −5 |
| 11 | | | | | | | | |
| Example | 1 | Bz | 0.86 | Bt | 1.76 | — | 60 | −5 |
| 12 | | | | | | | | |
| Example | 1 | PhBz | 0.86 | Ac | 1.76 | — | 60 | −5 |
| 13 | | | | | | | | |
| Example | 1 | Bz | 0.86 | Ac | 1.76 | — | 40 | −5 |
| 14 | | | | | | | | |
| Example | 1 | Bz | 0.86 | Ac | 1.76 | — | 70 | −5 |
| 15 | | | | | | | | |
| Example | 3 | Bz | 0.94 | Ac | 1.76 | A | 60 | −5 |
| 16 | | | | | | | | |
| Example | 3 | Bz | 0.94 | Ac | 1.76 | B | 60 | −5 |
| 17 | | | | | | | | |
| Example | 1 | Bz | 0.73 | Pr | 1.76 | — | 40 | 5 |
| 18 | | | | | | | | |
| Example | 1 | Bz | 0.73 | Ac | 1.76 | — | 30 | 10 |
| 19 | | | | | | | | |
| Example | 1 | Bz | 0.56 | Ac, Pr | 1.76 | — | 60 | −5 |
| 20 | | | | | | | | |
| Example | 1 | Bz | 0.73 | Ac, Pr | 1.76 | — | 30 | 10 |
| 21 | | | | | | | | |

| | | | Optical | | | | |
|---|---|---|---|---|---|---|---|
| | Draw | | characteristics | | Degree of | Ratio of | |
| | ratio [%] | | [nm] | | cross-sectional | sound | Display |
| | MD | TD | Re | Rth | orientation | velocity | characteristics |
| Example 1 | 5 | 65 | 152 | 22 | 0.073 | 1.32 | B |
| Example 2 | 10 | 65 | 170 | −37 | 0.081 | 1.28 | B |
| Example 3 | 15 | 65 | 199 | −5 | 0.085 | 1.25 | A |
| Example 4 | 10 | 65 | 227 | −29 | 0.079 | 1.28 | A |
| Example 5 | 5 | 65 | 243 | −46 | 0.075 | 1.32 | B |
| Example 6 | 5 | 60 | 250 | 10 | 0.078 | 1.30 | A |
| Example 7 | 10 | 65 | 254 | 45 | 0.078 | 1.28 | B |
| Example 8 | 15 | 65 | 344 | −9 | 0.084 | 1.25 | B |
| Example 9 | 15 | 65 | 201 | −39 | 0.084 | 1.25 | A |
| Example | 7 | 60 | 176 | −49 | 0.071 | 1.28 | B |
| 10 | | | | | | | |
| Example | 10 | 65 | 230 | −28 | 0.08 | 1.28 | A |
| 11 | | | | | | | |
| Example | 10 | 65 | 233 | −31 | 0.079 | 1.28 | A |
| 12 | | | | | | | |
| Example | 15 | 65 | 249 | −24 | 0.085 | 1.25 | A |
| 13 | | | | | | | |
| Example | 5 | 65 | 165 | −33 | 0.074 | 1.32 | B |
| 14 | | | | | | | |
| Example | 10 | 65 | 261 | −32 | 0.08 | 1.28 | A |
| 15 | | | | | | | |
| Example | 15 | 65 | 212 | −37 | 0.083 | 1.25 | A |
| 16 | | | | | | | |
| Example | 15 | 65 | 209 | −37 | 0.083 | 1.25 | A |
| 17 | | | | | | | |
| Example | 0 | 120 | 260 | 24 | 0.097 | 1.60 | A |
| 18 | | | | | | | |
| Example | 0 | 140 | 245 | 12 | 0.099 | 1.68 | A |
| 19 | | | | | | | |
| Example | 10 | 65 | 224 | −25 | 0.078 | 1.28 | A |
| 20 | | | | | | | |
| Example | 0 | 140 | 251 | 11 | 0.099 | 1.68 | A |
| 21 | | | | | | | |

*1“Bz” represents a benzoyl group, “PhBz” represents a phenylbenzoyl group, “Ac” represents an acetyl group, “Pr” represents a propionyl group, “Bt” represents a butyryl group, and “Ac, Pr” represents inclusion of both an acetyl group and a propionyl group.
*2Drawing temperature-Glass transition temperature Tg
*3Additive A is a plasticizer of an acryl-based polymer “DIANAL BR-83” (methyl polymethacrylate, molecular weight of approximately less than 40, manufactured by Mitsubishi Rayon Co., Ltd.), and Additive B is a plasticizer of a polyester-based polymer which is the above exemplified compound P-45.

TABLE 7

| | | | | | | | | Drawing |
|---|---|---|---|---|---|---|---|---|
| | Cellulose | Aromatic acyl group | | Aliphatic acyl group | | | Film | temperature |
| | acylate | | Degree of | | Degree of | Kind of | thickness | [° C.] |
| | solution | Kind*1 | substitution | Kind*1 | substitution | additive | [μm] | (ΔTg)*2 |
| Example 1 | 1 | Bz | 0.8 | Ac | 1.76 | — | 60 | −5 |
| Example 2 | 1 | Bz | 0.86 | Ac | 1.76 | — | 60 | −5 |
| Example 3 | 1 | Bz | 0.83 | Ac | 1.76 | — | 60 | −5 |
| Example 4 | 1 | Bz | 0.86 | Ac | 1.76 | — | 110 | −5 |
| Example 5 | 1 | Bz | 0.88 | Ac | 1.76 | — | 50 | −5 |
| Example 6 | 1 | Bz | 0.93 | Ac | 1.76 | — | 60 | −5 |

| | Draw | | Optical | | | | |
|---|---|---|---|---|---|---|---|
| | ratio | | characteristics | | Degree of | Ratio of | |
| | [%] | | [nm] | | cross-sectional | sound | Display |
| | MD | TD | Re | Rth | orientation | velocity | characteristics |
| Example 1 | 0 | 60 | 256 | 55 | 0.061 | 1.33 | C |
| Example 2 | 0 | 60 | 240 | −78 | 0.065 | 1.33 | C |
| Example 3 | 0 | 60 | 135 | −63 | 0.067 | 1.33 | C |
| Example 4 | 15 | 65 | 355 | −10 | 0.085 | 1.25 | C |
| Example 5 | 0 | 60 | 130 | −30 | 0.064 | 1.33 | C |
| Example 6 | 0 | 45 | 132 | −101 | 0.058 | 1.26 | C |

*1“Bz” represents a benzoyl group, “PhBz” represents a phenylbenzoyl group, “Ac” represents an acetyl group, “Pr” represents a propionyl group, and “Bt” represents a butyryl group.
*2Drawing temperature-Glass transition temperature Tg

TABLE 8

| | | | Drawing | Draw | | Optical | | | | |
|---|---|---|---|---|---|---|---|---|---|---|
| | | Film | temperature | ratio | | characteristics | | Degree of | Ratio of | |
| | | thickness | [° C.] | [%] | | [nm] | | cross-sectional | sound | Display |
| | Material*1 | [μm] | (ΔTg)*2 | MD | TD | Re | Rth | orientation | velocity | characteristics |
| Reference | DAC | 60 | 20 | 0 | 30 | 50 | 112 | 0.08 | 1.18 | — |
| example 1 | | | | | | | | | | |
| Reference | DAC | 60 | 20 | 15 | 40 | 56 | 129 | 0.094 | 1.13 | — |
| example 2 | | | | | | | | | | |
| Reference | PS | 60 | 0 | 0 | 30 | 151 | −166 | — | 1.18 | — |
| example 3 | | | | | | | | | | |
| Reference | PS | 60 | 0 | 15 | 40 | 153 | −187 | — | 1.13 | — |
| example 4 | | | | | | | | | | |

*1Reference examples 1 and 2 are the evaluation results of cellulose diacetate films, and Reference examples 3 and 4 are the evaluation results of polystyrene films.
*2Glass transition temperature Tg-Drawing temperature

As shown in the above tables, since the optical films of the examples all have a degree of cross-sectional orientation of 0.07 to 1, and exhibit optical characteristics of high Re and low |Rth|, it is understandable that the display characteristics significantly improve in a case in which the optical film is used in a horizontal orientation mode liquid crystal display apparatus of an IPS mode or the like.

Meanwhile, since the optical films of Comparative examples 1 to 6 have at least any one of Re, |Rth|, and the degree of cross-sectional orientation outside the scope of the invention, it is understandable that the effect of improving the display characteristics cannot be obtained in a case in which the optical film is used in a horizontal orientation mode liquid crystal display apparatus of an IPS mode or the like. Among the films of the comparative examples, the films that have been subjected to a uniaxial drawing treatment have a degree of cross-sectional orientation of less than 0.07, and therefore, compared to the examples, it is understandable that the films do not become an ideal film having a high Re and a low |Rth|.

Reference examples 1 to 4 are reference examples for explaining the tendency of the development of the optical characteristics of a uniaxial drawing treatment and a biaxial drawing treatment for polymer films which are not the film of the invention.

For films including cellulose diacetate not having an aromatic acyl group and polystyrene as principle components respectively, it is understandable that |Rth| increases in Reference examples 2 and 4 which have been subjected to a biaxial drawing treatment compared to Reference examples 1 and 3 which have been subjected to a uniaxial drawing treatment. As such, it can be said that the fact that |Rth| decreases when a biaxial drawing treatment is carried out on a film including cellulose acylate having the substituent A (aromatic acyl group A) as a principle component cannot be expected unlike the correlation between the drawing treatment and the development of the optical characteristics of known films of the related art.

What is claimed is:

1. An optical film which comprises a composition that includes cellulose acylate having an acyl group including an aromatic group and satisfies following formulae (I) to (III):
150 nm≦Re (550)≦350 nm Formula (I)
−50 nm≦Rth (550)≦50 nm Formula (II)
0.07 nm≦degree of cross-sectional orientation P2z≦1 Formula (III)
here, Re (550) represents an in-plane retardation at a wavelength of 550 nm, and Rth (550) represents a thickness direction retardation at a wavelength of 550 nm.

2. The optical film according to claim 1,
wherein a ratio VT/VM between a sound velocity VM in a predetermined direction of the film and a sound velocity VT in a direction orthogonal to the predetermined direction of the film is 1.0 to 1.4.

3. The optical film according to claim 2,
wherein the predetermined direction is a slow axis direction of the film.

4. The optical film according to claim 1,
wherein the acyl group including the aromatic group is selected from a benzoyl group, a phenylbenzoyl group, a 4-heptylbenzoyl group, a 2,4,5-trimethoxybenzoyl group, and a 3,4,5-trimethoxybenzoyl group.

5. The optical film according to claim 2,
wherein the acyl group including the aromatic group is selected from a benzoyl group, a phenylbenzoyl group, a 4-heptylbenzoyl group, a 2,4,5-trimethoxybenzoyl group, and a 3,4,5-trimethoxybenzoyl group.

6. The optical film according to claim 1 further having an aliphatic acyl group.

7. The optical film according to claim 2 further having an aliphatic acyl group.

8. The optical film according to claim 3 further having an aliphatic acyl group.

9. The optical film according to claim 4 further having an aliphatic acyl group.

10. The optical film according to claim 6,
wherein the aliphatic acyl group is one or two or more aliphatic groups selected from an acetyl group, a propionyl group, and a butyryl group.

11. The optical film according to claim 7,
wherein the aliphatic acyl group is one or two or more aliphatic groups selected from an acetyl group, a propionyl group, and a butyryl group.

12. The optical film according to claim 1 which is a biaxially drawn film.

13. The optical film according to claim 2 which is a biaxially drawn film.

14. The optical film according to claim 1,
wherein a film thickness is 40 μm to 70 μm.

15. The optical film according to claim 1 further comprising:
at least one plasticizer.

16. A polarizing plate comprising:
at least the optical film according to claim 1; and
a polarizer.

17. A liquid crystal display apparatus comprising:
the polarizing plate according to claim 16.

18. A method of manufacturing a cellulose acylate film that satisfies the following formulae (I) and (II), comprising:
a film-forming process in which a composition that includes cellulose acylate having an acyl group including an aromatic group is formed into a film, and
a drawing process in which a drawing treatment is carried out on the obtained film,
wherein the drawing treatment is carried out under a condition that a degree of cross-sectional orientation P2z of the drawn film satisfies a following formula (III)
150 nm≦Re (550)≦350 nm Formula (I)
−50 nm≦Rth (550)≦50 nm Formula (II)
0.07 nm≦degree of cross-sectional orientation P2z≦1 Formula (III)
here, Re (550) represents an in-plane retardation at a wavelength of 550 nm, and Rth (550) represents a thickness direction retardation at a wavelength of 550 nm.

19. The method according to claim 18,
wherein the drawing process is a process in which biaxial drawing that carries out a drawing treatment on the formed film in a film-forming direction and a direction orthogonal to the film-forming direction is carried out.

20. The method according to claim 18,
wherein the drawing process is a process in which the formed film is drawn in a film-forming direction at a draw ratio r_{MD}, and then is drawn in a direction orthogonal to the film-forming direction at a draw ratio r_{TD} (here, r_{MD}<r_{TD}).
